(19) United States
(12) Patent Application Publication
(10) Pub. No.: US 2026/0148075 A1
(43) Pub. Date: May 28, 2026

(54) Scalable Framework for 3D Molecular Design via Language Modeling and Reinforcement Learning

(71) Applicants: Insilico Medicine IP Limited, Hong Kong (HK); Insilico Medicine AI Limited, Abu Dhabi (AE)

(72) Inventors: Artem Zholus, Montréal (CA); Maksim Kuznetsov, Montréal (CA); Roman Schutski, Moscow (RU); Rim Shayakhmetov, Montréal (CA); Daniil Polykovskiy, Montréal (CA); Aleksandrs Zavoronkovs, Hong Kong (HK)

(21) Appl. No.: 19/178,490

(22) Filed: Apr. 14, 2025

Related U.S. Application Data
(60) Provisional application No. 63/634,237, filed on Apr. 15, 2024.

(51) Int. Cl. G06N 3/0895; G06N 3/092

(52) U.S. Cl. CPC G06N 3/0895; G06N 3/092

(57) ABSTRACT

A computer-implemented method may use a neural network-based language model for generating a 3D structure of a molecule conditioned by atomic connectivity or a binding of the molecule with a target protein pocket. The language model may be trained with the large-scale training data set to obtain a pre-trained language model, wherein the pre-trained language model may be trained to generate the 3D structures of molecules and/or protein pockets. The pre-trained language model may be trained with the finetuning training data to obtain a finetuned language model capable of at least one of: generating 3D structures of molecules capable of binding to the target protein pockets or generating 3D structures of molecules bound in the target protein pockets or generating 3D structures of the target protein pockets. The trained language model capable of generating the 3D structure of a generated molecule that binds with the protein pocket.

### CROSS-REFERENCE TO RELATED APPLICATIONS

This patent application claims priority to U.S. Provisional Application No. 63/634,237 filed Apr. 15, 2024, which provisional is incorporated herein by specific reference in its entirety.

### BACKGROUND

### Field

The present disclosure relates to the field of computational chemistry and molecular modeling. More specifically, it pertains to generating three-dimensional structures of molecules and protein pockets using machine learning techniques with large language models.

### Background

The design of small molecular structures with desired properties is one of the fundamental tasks in drug discovery. Generative models have proven to be helpful in this process, offering the ability to explore vast chemical space more efficiently by suggesting the most promising drug candidates. Among these methods, diffusion models have gained popularity for their flexibility to capture a complex target distribution of 3D molecular structures. Moreover, these models can accommodate external guidance allowing for adjustments to the sampling distribution without retraining the model.

Apart from available datasets, the drug discovery domain features various expert knowledge, which is crucial for narrowing down the search space. One way to provide this knowledge to a model involves conditioning the generation process on the prior structural information, such as privileged fragments, pharmacophore points and/or protein pocket. Privileged fragments provide a scaffold to guide the exploration of chemical space, ensuring the generated molecules possess structural elements associated with favorable pharmacological properties. The inclusion of pharmacophore points serves a similar goal but allows for more flexibility as a single pharmacophore point can correspond to multiple fragments and specifies the direction of the corresponding fragments in 3D space. Finally, accounting for protein pocket constraints acknowledges the spatial and structural information of target proteins, resulting in generating molecules with improved binding affinities.

The landscape of drug discovery presents immense challenges and risks, demanding substantial investments of time and resources to design, test, and deliver new medicines to the market. Within this context, Computer-Aided Drug Design (CADD) (Yu & MacKerell, 2017) stands as a pivotal methodology, harnessing software screenings and physical simulations to facilitate a more efficient exploration of the vast space of drug-like molecules (Polishchuk et al., 2013; Gomez-Bombarelli et al., 2018). Deep learning advancements have revolutionized this exploration by leveraging neural generative models trained on extensive compound datasets. Notably, the textual representation of molecular structures using SMILES (Weininger, 1988) and SELFIES (Krenn et al., 2020) has enabled the utilization of Language Models for the generation of novel, drug-like molecular compounds (Segler et al., 2018; Bagal et al., 2022).

Recent research has demonstrated the capability of deep generative models to generate novel molecular compounds directly in 3D, with the flexibility to incorporate protein pocket and ligand subfragment conditions. Among these, diffusion models such as EDM (Hoogeboom et al., 2022) and DiffDock (Corso et al., 2023) initiate the generation process with an arbitrary spatial distribution of atoms and progressively refine their positions to yield physically viable molecular structures. Meanwhile, autoregressive models like Pocket2Mol (Peng et al., 2022) sequentially predict the type and location of each successive atom, building upon the existing molecular framework. Additionally, previous work (Flam-Shepherd et al., 2023) has highlighted the proficiency of language models in handling spatial representations of molecular and protein structures through formats like XYZ, CIF, and PDB. However, it is noteworthy that most spatial molecular generators focus exclusively on atom types and locations. They depend on supplementary tools, such as OpenBabel (O'Boyle et al., 2011), for the critical task of bond reconstruction. This reliance can introduce vulnerabilities, as the precision required for atom placement means that minor positional adjustments can significantly alter reconstructed molecular bonds or even make the molecular graph disconnected.

Small drug-like molecules can be represented as 2D or 3D graphs with node and edge attributes. However, one of the most popular molecular representations in the machine learning community is SMILES (Weininger, 1988), which can be seen as a compressed textual encoding of the Depth-First-Search applied to the molecular graph. The simplicity of SMILES and expressivity made it work very well with language models—even a simple LSTM (Hochreiter & Schmidhuber, 1997) model can outperform graph-neural networks for the molecule generation task (Flam-Shepherd et al., 2022). In addition, SELFIES (Krenn et al. 2022), is a modification of SMILES which is a robust string representation such that every SELFIES token sequence is a valid molecule and vice versa.

The biological function of small molecules arises through their binding to specific protein pockets. The spatial structure of the protein pocket is an essential domain knowledge to increase the efficiency of molecular generation in drug design tasks. With the increase of molecular structure datasets sizes (Francoeur et al., 2020; Hu et al., 2005) a plethora of pocket-conditioned generators emerged (Peng et al., 2022; Luo et al., 2022; Lin et al., 2022; Corso et al., 2023). The challenge with pocket-conditioned molecular generation arises from a relatively small size of existing 3D binding poses datasets, which motivated a heavy use of specialized architectures, like SE(3) equivariant neural networks (Hoogeboom et al., 2022).

Apart from language models, there exist other types of generative models that approach molecule generation, including 3D-aware models. The first group of works uses diffusion models, which employ the denoising diffusion process (Ho et al., 2020; Song et al., 2021) to learn to recover the data from noise. The second group of works relies on Graph Neural Networks (GNNs) to autoregressively build 2D or 3D molecular graphs. These approaches can be combined as GNNs can serve as efficient backbones for diffusion process once they are node-equivariant (Niu et al., 2020) to generate 2D graphs, or SE(3)-equivariant (Peng et al., 2023b). The SBDD (Luo et al., 2022) model uses autoregressive graph generation for pocket-conditioned molecule generation. The TargetDiff (Schneuing et al., 2023) generalizes this model to use a diffusionGNN for the same task. Pocket2Mol (Peng et al., 2022) uses an informed autoregressive sampling mechanism for efficient pocket-conditioned molecule generation. Another batch of works use the aforementioned methods for the unconditional molecule generation. EDM (Hoogeboom et al., 2022) proposes an E(3) equivariant diffusion model for molecule generation. MolDiff (Peng et al., 2023) is a diffusion model that addresses the inconsistency problem between generated atoms and bonds connecting them.

The language models show outstanding results in the drug discovery domain. The molecular structures can be easily represented in a textual formats like SMILES (Segler et al., 2018) or SELFIES (Flam-Shepherd et al., 2022), enabling the effective training of well-known language model architectures on large datasets of chemical entities. Recent studies reveals the potential of applying language models to address various challenges in drug discovery. For instance, LigGPT (Bagal et al., 2022) leverages the GPT (Radford et al., 2018) architecture to generate molecular structures given the conditions of molecular descriptors. MoLFormer (Katharopoulos et al., 2020) incorporates billion-size chemical entities database to perform large-scale pretrain and further finetune to predict molecular properties. BARTSmiles (Chilingaryan et al., 2022) is developed atop of BART (Lewis et al., 2019) architecture, training a meaningful chemical representation and refining it for tasks such as chemical property prediction, chemical reaction prediction, and retrosynthesis.

However, the challenge of 3D molecule generation has received limited attention in the language model approach. Three notable studies in this area include the XYZ-transformer (Flam-Shepherd et al., 2023), Uni-Mol (Zhou et al., 2023), and Lingo3DMol (Feng et al., 2024). The XYZ-transformer leverages GPT for generating atom-wise description of molecular and protein structures. Uni-Mol modifies BERT for large-scale pretraining on a large 3D structures dataset. In particular, Uni-Mol formulates molecular tasks as coordinates-to-coordinates mapping given molecular graph.

Large language models (LLM) show overwhelming performance and dominance in natural language tasks because they are able to learn meaningful word representations based on the textual context, translate from one language to another and keep the dialog going for different topics.

Several works showed that LLMs are able to understand not only the natural language but also chemical languages like SMILES (e.g., Galactica, MolFormer, ChemFormer, MolT5, T5Chem) and amino acid sequences (e.g., ProGen, RGN2). The models can work with text chemical data both as an input (e.g., molecular property prediction), as an output (e.g., molecular generation) or both (e.g., reaction prediction). Still the huge gap between structural (2D) and spatial (3D) chemical data exists. The protein 3D structure prediction problem was one of the most fundamental and difficult computational tasks before the AlphaFold architecture invention. In the majority of drug discovery tasks, the protein pocket 3D representation is an essential component to discover the ligand compounds that can bind and change the activity of the protein (e.g., MolDiff, DiffLinker).

The recent works showed that LLM are able to fuse the different data modalities (e.g., texts/images/audio) to enhance the generalizability of the model and move towards foundational models. Several published models (e.g., Gill, IDEFICS) can take as an input text query and optionally image to produce the text answers. The main idea of multi-modal large language models is based on the concept of introducing additional domain-specific encoders that convert non-text data to the hidden embeddings that can be added alongside with text token embeddings in the model input.

The field of computational chemistry and drug discovery has seen significant advancements in recent years, particularly in the area of molecular structure prediction and generation. However, accurately predicting three-dimensional (3D) structures of molecules and protein-ligand complexes remains a challenging task. Traditional methods often struggle with balancing computational efficiency and structural accuracy, especially when dealing with large and complex molecular systems.

One of the key challenges in this field is the generation of novel molecules that can bind effectively to specific protein targets. This process, known as structure-based drug design, is crucial for developing new therapeutic compounds. However, existing computational approaches often face limitations in exploring the vast chemical space efficiently while maintaining structural accuracy.

Another significant hurdle is the representation and processing of 3D structural data in machine learning models. Many current methods rely on specialized architectures with strong inductive biases, which may limit their flexibility and generalization capabilities. Additionally, the scarcity of high-quality 3D structural data, particularly for protein-ligand complexes, poses a challenge for training robust predictive models.

Furthermore, integrating various aspects of molecular design—such as generating molecular graphs, predicting 3D conformations, and optimizing for protein binding—into a unified framework has proven difficult. Many existing pipelines treat these as separate steps, potentially leading to suboptimal results and increased computational overhead.

In the realm of artificial intelligence and machine learning, recent advancements in natural language processing, particularly in the development of large language models, have shown promise in tackling complex sequential data. However, the application of these techniques to 3D molecular structures has been limited, leaving an opportunity for innovation in this space.

There is a growing need for computational methods that can efficiently generate diverse, high-quality 3D molecular structures tailored to specific protein targets. Such methods could significantly accelerate the drug discovery process by enabling rapid in silico screening of potential drug candidates before moving to costly experimental validation stages.

Addressing these challenges could lead to more efficient and accurate tools for molecular design, potentially revolutionizing the field of computational drug discovery and opening new avenues for the development of novel therapeutics.

### SUMMARY

In some embodiments, a computer-implemented method may input into a computing system a neural network-based language model for generating a 3D structure of a molecule conditioned by atomic connectivity or a binding of the molecule with a target protein pocket. The method may input large-scale training data into the computing system, which may include a 3D structure of a molecule, a target protein pocket, or a binding of the molecule with the target protein pocket. The language model may be trained with the large-scale training data set to obtain a pre-trained language model, wherein the pre-trained language model may be trained to generate the 3D structures of molecules and/or protein pockets. The method may input finetuning training data into the computing system regarding a second set of a binding of the molecule with the target protein pocket. The pre-trained language model may be trained with the finetuning training data to obtain a finetuned language model capable of at least one of: generating 3D structures of molecules capable of binding to the target protein pockets, or generating 3D structures of molecules bound in the target protein pockets, or generating 3D structures of the target protein pockets that can be capable of binding with a molecule (e.g., of the data set or generated). The method may perform reinforcement learning training with the finetuned language model to obtain a trained model of the 3D structure, wherein the reinforcement learning data may include random rotations to protein pocket coordinates of the target protein pocket. The method may provide the trained language model capable of generating the 3D structure of at least one generated molecule that fits into the target protein pocket, or a 3D structure of the generated molecule defined by atomic connectivity that fits into the target protein pocket, or a 3D structure of the generated molecule without specific binding.

The 3D structure may be represented as a textual representation. The textual representation may include a token scheme to encode 3D spatial data into a sequence of tokens. A training-time data augmentation procedure may be performed to increase accuracy of 3D structure generation when the training set lacks sufficient 3D coordinate data. 3D molecular structures may be represented as a molecular structure text that may start with a specific token (e.g., <LIGAND> token) followed by a SMILES string. The SMILES may be a textual encoding of a depth-first pass applied to a molecular graph of a molecule. The SMILES string may encode connectivity between atoms. The SMILES may be tokenized so that each atomic symbol may have its own token. However, other chemical line notation schemes other than SMILES can be used in the present technology.

In some embodiments, a computer system can include: one or more processors; and one or more non-transitory computer readable media storing instructions that in response to being executed by the one or more processors, cause the computer system to perform operations, the operations comprising the method of one of the embodiments described herein.

In some embodiments, a device includes one or more non-transitory computer readable media storing instructions that in response to being executed by one or more processors, cause a computer system to perform operations, the operations comprising the method of one of the embodiments.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 includes a flow diagram for a 3D molecule pretraining-finetuning paradigm.

FIG. 2 includes a flow diagram of a data processing layout that can be used during the pretraining. The arrows show the tokens sequence order. Nodes, such as <POCKET>, <XYZ> or <LIGAND> show special tokens. Training is done on a mixture of pocket and ligand datasets.

FIG. 3A illustrates a flow diagram of a pocket-conditioned finetuning protocol.

FIG. 3B illustrates a flow diagram of a pocket and reward conditioned finetuning protocol.

FIG. 4A shows the sampled confirmations for reference molecules from the Platinum dataset.

FIG. 4B shows the RMSD coverage metric calculated on the Platinum dataset for the 3D conformation generation task.

FIG. 5 shows examples of binding poses and Vina scores (⬇) for 2 gns and 4d7o pockets.

FIG. 6 shows an example of a 3D molecule encoded as text that the model trains to predict.

FIG. 7 shows an example of the protein pocket encoded as text that the model trains to predict during pretraining.

FIG. 8 includes a graph of data for pretraining loss curves for different model sizes for the representation without explicit hydrogens.

FIG. 9 includes a graph that shows the test perplexity on the holdout Zinc-250 k dataset with 3D conformations from RDKit. BindGPT is the first model capable of this type of evaluation.

FIGS. 10A-10C include a set of graphs of data that show the ligand-pocket affinity objectives averaged over several runs for a reinforced learning finetuning stage: (FIG. 10A) Vina Score (FIG. 10B); Ligand connectivity; and (FIG. 10C) Synthetic Accessibility (SA).

FIG. 11 shows the 3D conformations generated by BindGPT with explicit hydrogens for a fixed molecule graph. No assistance tools are used. Also, no manual cherry-picking is used here.

FIG. 12 shows examples of generated molecules sampled from the BindGPT model without condition.

FIG. 13 shows examples of generated molecules for 4d7o pocket after the reinforced learning and finetuning. Note that no cherry picking (or other filtering) was performed and these are just the first 35 model samples.

FIG. 14 includes an example computing device that can be used in the methods described herein for performing computations.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to computing systems with trained models that are configured for application of the modern decoder-only language modeling paradigm to the 3D drug discovery problem, which can be used for several downstream applications.

In some embodiments, a multi-modal large language models is based on the concept of introducing additional domain-specific encoders that convert non-text data to the hidden embeddings that can be added alongside with text token embeddings in the model input. In some aspects, the protocols described herein can follow this approach to develop a new model that can work both with chemical text and spatial (3D) data.

Generating novel active molecules for a given protein is an extremely challenging task for generative models that requires an understanding of the complex physical interactions between the molecule and its environment. A novel generative model, is provided that uses a conceptually simple but powerful approach to create 3D molecules within a target protein binding site. The model produces molecular graphs and conformations jointly, thereby eliminating the need for an extra graph reconstruction step. The protocol pretrains the generative model on a large-scale dataset and fine-tunes it with reinforcement learning using scores from external simulation software. The technology demonstrates how a single pretrained language model can serve at the same time as a 3D molecular generative model, conformer generator conditioned on the molecular graph, and a pocket-conditioned 3D molecule generator. Notably, the model does not make any representational equivariance assumptions about the domain of generation. The technology provides a conceptual approach combined with pretraining and scaling that can perform on par or better than the current best specialized diffusion models, language models, and graph neural networks while being two orders of magnitude cheaper to sample.

Disclosed herein is a computing system and method for generating novel active molecules for a target protein using a generative model capable of understanding complex physical interactions between a molecule and its surrounding environment (e.g., target protein binding site). The disclosed invention provides a novel generative model, referred to as BindGPT, which employs a computationally efficient and conceptually simplified approach to generate three-dimensional (3D) molecular structures within a specified (e.g., target) protein binding site. Unlike existing methodologies, the disclosed model concurrently generates molecular graphs and corresponding conformations, thereby obviating the need for an additional graph reconstruction step. The model is initially pretrained on a large-scale molecular dataset and subsequently fine-tuned using reinforcement learning, wherein external simulation software provides feedback scores to optimize molecular generation. The disclosed model functions as a multi-purpose molecular generation framework, serving as a 3D molecular generative model, a conformer generator conditioned on molecular graphs, and a pocket-conditioned 3D molecule generator. Notably, the system does not impose any explicit representational equivariance constraints on the molecular generation process, allowing for a more flexible and scalable approach. Experimental results demonstrate that the disclosed system, when combined with pretraining and scalability enhancements, achieves performance on par with or superior to state-of-the-art diffusion models, language models, and graph neural networks, while maintaining computational efficiency by reducing sampling costs by approximately two orders of magnitude.

In some embodiments, the present invention provides a novel framework that applies language modeling to the domain of 3D molecular data represented by textual tokens. This entirely data-driven approach, devoid of any inductive biases at both the model and representation levels, capitalizes on the established GPT paradigm, integrating cutting-edge techniques to enhance the scalability of model training and inference. By adopting the language model pretraining paradigm, the inventive framework showcases the ability of a trained model to become a powerful causal language model adept at navigating the complex space of 3D molecules. This proficiency is demonstrated through successful applications in downstream tasks, including learning the distribution of 3D molecules, generating 3D conformations, and the generation of molecules with targeted binding affinity to specific proteins.

In some embodiments, the present invention includes the BindGPT, which is a LLM for handling spatial molecular structures in text format. The model uses structural SMILES and spatial XYZ formats to describe molecular graphs and atom locations. The use of BindGPT eliminates the dependency on external software for graph reconstruction. However, while SMILES is described herein, other chemical line notation systems can be used to textually define the 3D structure of the molecules.

In some embodiments, the BindGPT can be used in a scalable pretraining-finetuning method for drug discovery in 3D that covers several 3D molecular generation tasks in a single paradigm.

In some embodiments, the BindGPT can create accurate and realistic 3D molecular structures with both zero-shot and after finetuning, with the option to include molecular graphs or protein pocket descriptions as prompts. The method offers comparable generation quality to leading approaches with the speedup of up to 100 times.

In some embodiments, the BindGPT can be improved and trained, such as with a reinforcement learning (RL) framework to finetune BindGPT with an external feedback from docking software. The resulting trained BindGPT model can find structures with high binding scores for any given protein as a result for the reinforced learning finetuning.

In some embodiments, BindGPT is a GPT-like language model for unconditional molecular generation, conformer generation, and protein pocket conditional molecular generation. To achieve high quality of molecular generation, the model uses: (a) a custom textual representation scheme and tokenization scheme, to encode spatial (3D) structure of molecules; (b) a custom training-time data augmentation procedure to compensate for scarcity of training data; and (c) a 3-step training scheme: large scale pretraining, fine-tuning, and reinforcement learning. The latter is standard in language models, but now can also be used for applications for molecule generation.

In some embodiments, a computer-implemented method can utilize an autoregressive token generation model, influenced by GPT-based models, to solve several 3D small molecule generation tasks in one simple yet flexible paradigm. A principle in the method is to formulate several 3D molecular design tasks as prompted generation of text. To achieve that, the method sets forth the tokens of a condition before setting forth the tokens of the object to generate. For instance, a prompt can be the protein pocket for the pocket-conditioned generation task or the 2D molecular structure for the conformation generation task.

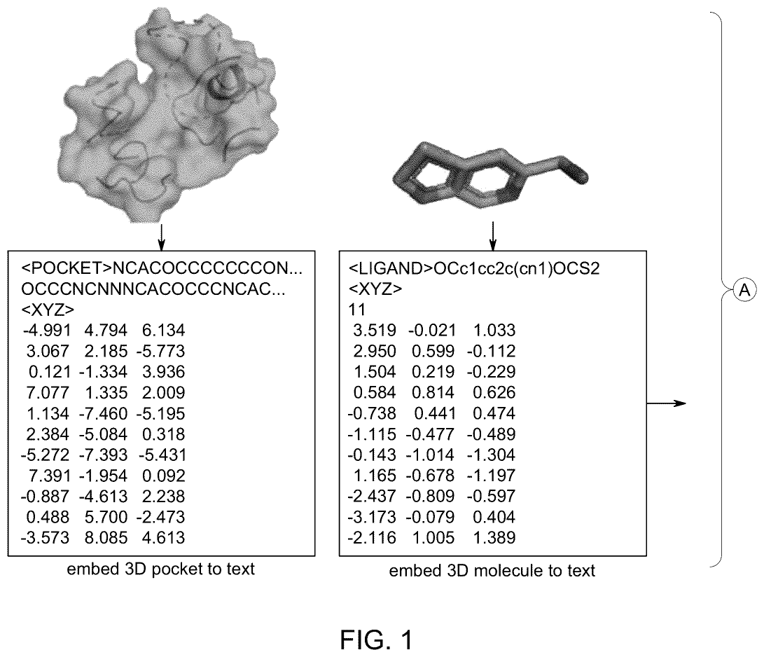

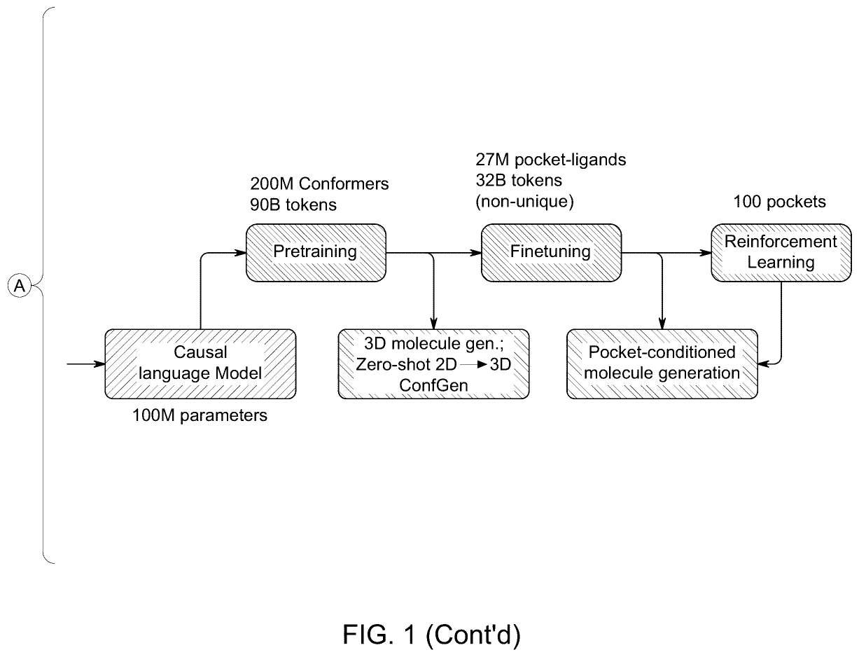

FIG. 1 illustrates a flow diagram for a 3D molecule pretraining-finetuning paradigm. Each of the functions can be implemented by a module or other computing functionality of the computing system. During pretraining the model is trained on a mix of molecules and pockets in isolation. By finetuning, the training concatenates the pocket text representation and the molecule text representation for each pocket-ligand pair. FIG. 1 shows the encoding of the molecular data and three stage training.

In some embodiments, the present technology trains the language model with a standard autoregressive objective, such as to predict next token in the input. During pretraining, the protocol trains the model on pocket and ligand blocks separately. To alleviate scarcity of 3D protein structures, the protocol up samples protein pockets in a 5 to 1 ratio to ligands (other ratios may be used too).

During fine-tuning, the protocol trains the model on combined strings, which include a pocket followed by a ligand. The protocol applies two augmentations to the data. The protocol randomizes SMILES strings with a procedure (Bjerrum, 2017), such as to choose different depth-first passes of the molecular graph during each training step. A corresponding permutation is applied to the coordinate part. The protocol applies random rotations to protein pocket and ligand coordinates using the same rotation matrix.

During the reinforcement learning step, the protocol applies random rotations to protein pocket coordinates. These techniques can help avoid overfitting with currently available datasets.

The training procedure of the described protocol includes large-scale pretraining, finetuning, and reinforcement learning steps. Now, the protocol can be applied to the molecular domain. The examples show in experiments that omission of pretraining or of the fine-tuning step significantly inhibits the quality of the resulting trained model.

In some embodiments, the model is configured as a decoder-only paradigm in Language Models used for GPT-NeoX architecture (Black et al., 2022) that utilizes rotary position embeddings (Su et al., 2021). This technique allows for the length generalization, which is required since the sequence lengths may vary significantly between the pretraining, and fine-tuning stages.

The present protocol uses the XYZ representation as a base format to describe the spatial atom allocation. The idea of the XYZ format is to represent the atom type and its 3D coordinates within every line of text. The main drawback of this format is the lack of charge and connectivity information. In some aspects, a checking method can use external software like RDKit (Landrum et al., 2024) or OpenBabel (O'Boyle et al., 2011) to reconstruct the molecular graph to check validity. It introduces an instability since even small noise in atom positions can drastically change the reconstructed graph or even break it down (Peng et al., 2023a). To alleviate that, the protocol couples the XYZ format with the SMILES format. The latter can efficiently represent the molecular structure, while the former allows describing atom positions. To align these two formats, the protocol can enforce having the same atom ordering in both. The protocol also remove the atom symbol from the XYZ representation as it already was shown in SMILES. For proteins, there is no need to describe their connectivity, therefore the protocol simply writes atom names grouped by amino acids.

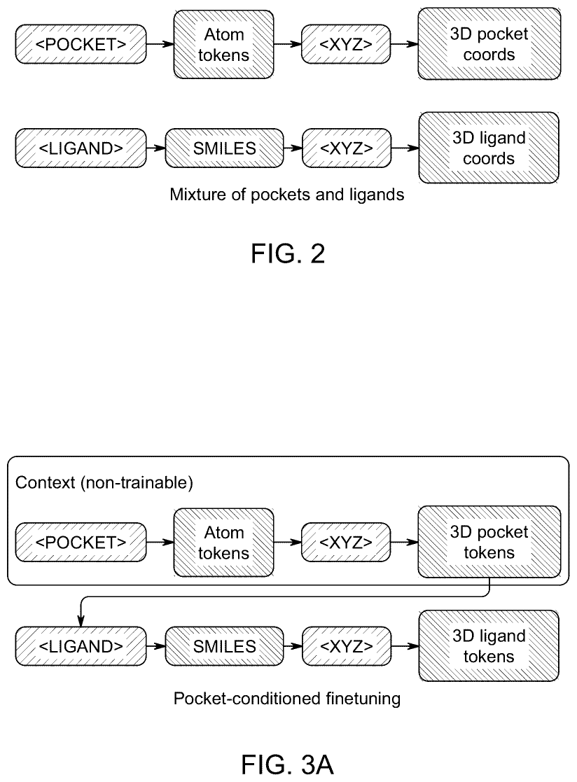

FIG. 2 includes a flow diagram of a data processing layout that can be used during the pretraining. The arrows show the tokens sequence order. Nodes, such as <POCKET>, <XYZ> or <LIGAND> show special tokens. Training is done on a mixture of pocket and ligand datasets.

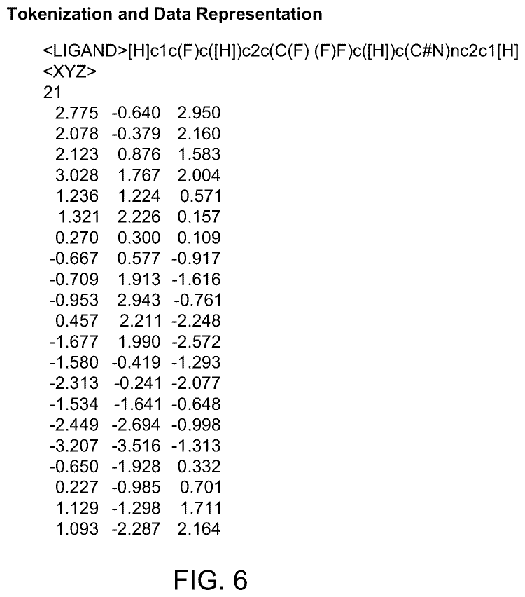

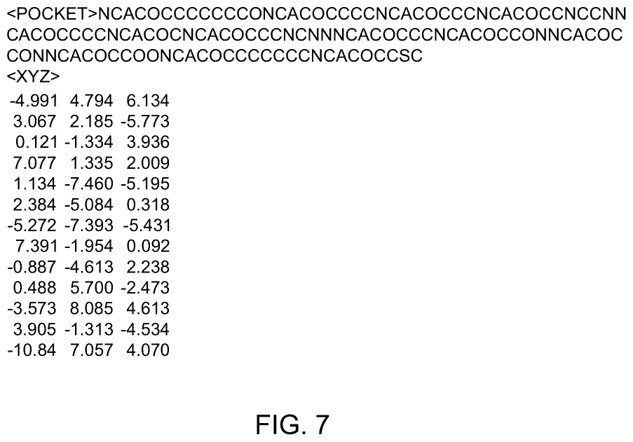

A schematic example of the two kind of the model input is shown in FIG. 2 and the very detailed example of concrete input sequences (including its tokenization) is shown in FIG. 6. In particular, the sequence starts with the <LIGAND> token followed by a SMILES string, tokenized at the character level. Next, the <XYZ> special token is used for marking the end of SMILES and the beginning of the coordinate part of the string. The tokenization strategy uses 6 tokens per 3D position: the protocol uses one token for the integer part and one token for the fractional part of the number. When working with protein pockets, the protocol uses a similar strategy. Specifically, the sequence begins with the <POCKET> token followed by the sequence of atoms where each atom is a separate token. Since pockets can be hundreds of atoms large, the protocol follows the AlphaFold's (Jumper et al., 2021) approach and retain only the 3D coordinates of the Alpha-carbon atoms in the corresponding amino acids. An example of the final representation of a pocket is shown in FIG. 7.

FIG. 6 shows an example of a 3D molecule encoded as text that the model trains to predict. The sequence starts with a special token indicating the beginning of a small molecule: <LIGAND> followed by a SMILES string, tokenized character-level. Next follows the <XYZ> special token marking the end of SMILES and the beginning of the coordinate part of the output. The coordinate part of the output starts with the number of atoms in the molecule followed by a series of 3D coordinates for each atom. Unlike the standard XYZ format, this representation does not include atom types before each coordinate due to the preceding SMILES string, which already provides atom sequence and connectivity. In this case, the order of 3D coordinates corresponds to the order of atoms as they appear in the SMILES string. Each coordinate triplet is encoded with six tokens: one token specifies the integer part with a sign and another one defines a fractional part of the floating point number.

FIG. 7 shows an example of the protein pocket encoded as text that the model trains to predict during pretraining. The sequence starts with a special token <POCKET> marking the beginning of the protein pocket sequence. After that, the protocol writes a sequence of heavy atoms ignoring the edge structure of the pocket part of the protein molecule. After that, the protocol write 3D coordinates of Alpha-Carbon atoms, each of which appears only once per amino acid. The tokenization of the 2D part of the pocket is character level (except for CA) and for the 3D part it is two tokens per real number like in the ligand tokenization.

In some embodiments, the text starts with the <LIGAND> token followed by a SMILES string. SMILES is a widely used textual encoding of the Depth-First pass applied to the molecular graph. SMILES string encodes the connectivity between atoms. The protocol tokenizes SMILES at character-level, such as each atomic symbol gets its own token.

Next, there is a section representing spatial (3D) information about the molecule. It starts with <XYZ> special token marking the end of SMILES string. Each next line of text is a triplet of X, Y, Z coordinates. The order of coordinates corresponds to the order of atoms in the SMILES string. The protocol tokenizes coordinates by assigning one token to the integer part and a possible sign, and another token to the 3-digit fractional part including dot. This results in 6 tokens per each 3D position.

A similar strategy is used to encode pocket information. The sequence starts with <POCKET> special symbol followed by a sequence of atomic symbols where each atom is a separate token. This section is followed by <XYZ> token marking the beginning of spatial coordinates. The protocol includes only coordinates of alpha carbon atoms of each amino acid which form a pocket.

### Pretraining

In some embodiments, the configuration and training protocol of the present model can follow the paradigm of LLMs, which can include: pretraining-finetuning, prompting, scaling, finetuning with reinforcement learning, tool use, etc. (Kaplan et al., 2020; Hoffmann et al., 2022; Radford et al., 2019). Since the present model covers only a specialized domain of molecular tasks, it does not require trillion-scale diverse datasets for good performance as NLP tasks do. Thus, the present model can use a large-scale but specialized dataset of 3D molecules and protein pockets for training.

During pretraining, the model can be operated with 108M (108 million) parameters having 15 layers, 12 heads, and a hidden size of 768. It was found that this size of the model is enough for the tasks for generating molecules in 3D. Every sequence in the training batch is either a ligand sequence of tokens or a pocket sequence of tokens following the scheme described earlier. Since the dataset has much fewer pockets than ligands, for one epoch of training on ligands, the protocol can do 5 epochs of training on proteins, that is, around 8% of all tokens seen by the model are pocket tokens. To improve and stabilize pretraining, the protocol uses large batch training (Keskar et al., 2017) with 1.6M (1.6 million) tokens per one training step. It was found that this many tokens per batch can be important for stable training in this task even with smaller learning rates. The detailed description of the training implementation is provided herein.

Despite the wide use of transformers in drug discovery, the majority of current works in this space do not use recent advancements of efficient LLM pretraining: neither technical ones, such as Flash-attention (Dao, 2023) or DeepSpeed (Rasley et al., 2020), nor the algorithmic ones, such as learning rate scaling. The present technology can be used with pretraining for 3D drug discovery.

### Supervised Finetuning

As a result of the pretraining, BindGPT gains an understanding of a broad chemical space. This comprehensive understanding enables the model to efficiently narrow down through the supervised fine-tuning on a specialized dataset. During the supervised fine-tuning phase, the protocol continues to perform model training on CrossDocked (Francoeur et al., 2020), which is a high-quality dataset containing aligned pocket-ligand pairs. Most of the prior methods subsample less than 1% of the best pocket-ligand pairs and they don't benefit from diversity and scale. To obtain a bigger version of CrossDocked, the protocol extract all intermediate ligand poses (e.g., with respect to the docking process), including the lower quality ones. Despite quite large size, CrossDocked was created by docking 14 k (14 thousand) unique molecules into 3 k (3 thousand) pockets (Francoeur et al., 2020). This is why the protocol observed a dramatic overfitting when training on the 1% version of CrossDocked and even on the full one. To alleviate that, the protocol resorts to two standard augmentation techniques used in drug discovery. First, the protocol uses SMILES randomization (Bjerrum, 2017), which can heavily randomize one molecule by yielding 100-1000 different SMILES strings (all corresponding to that molecule). Second, the protocol randomly rotates the 3D coordinates of the protein pocket and of the ligand (e.g., with the same rotation matrix). This way the trained model learns to understand structural and spatial properties of molecular binding beyond just token sequences.

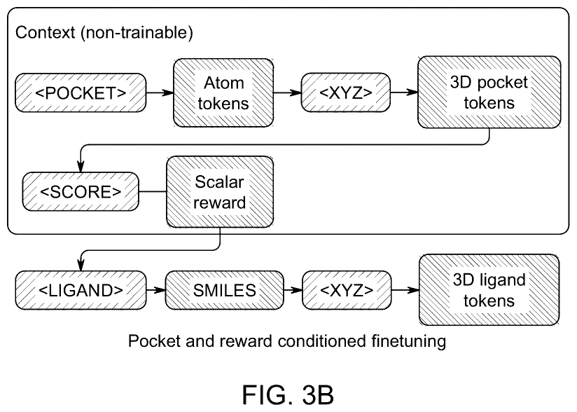

Since the pretrained BindGPT is trained on both ligands (starting from the <LIGAND> token) and pockets (starting from the <POCKET> token), the information about the structure of both is learned by the model. In the finetuning setup, the protocol represents each pocket-ligand pair as a string starting with the pocket string representation followed by the string representation of the ligand. Therefore, having learned them separately during pretraining, the finetuning exploits the independent knowledge of both pockets and ligands to learn a conditional dependency between them. In addition to that, since the utilized version of CrossDocked contains both high and low score conformations, the protocol tests another version of context where the training is conditioned on the pocket and binding energy score obtained from the CrossDocked dataset (e.g., which is originally computed through the docking software (Trott & Olson, 2010; Eberhardt et al., 2021)). This way the protocol can perform a variant of contrastive learning by learning the structure of good and bad examples. During evaluation of the model, the protocol can sample molecules conditioned on some desired value of the binding affinity. The input layout for both versions is shown in FIGS. 3A and 3B. FIG. 3A illustrates a flow diagram of a pocket-conditioned finetuning protocol. FIG. 3B illustrates a flow diagram of a pocket and reward conditioned finetuning protocol.

### Reinforcement Learning

Despite the ubiquitous use of reinforcement learning (RL) for language models in drug discovery, it has not been found to have been used within the pretraining paradigm of modern LLMs (Hoffmann et al., 2022; Kaplan et al., 2020; Ouyang et al., 2022). The main motivation to use RL after the pretraining/finetuning stages is to use the knowledge distilled into the model from massive amounts of less structured data. This is the first work performing reinforcement learning on molecules that utilizes knowledge from pretraining and supervised finetuning. Despite dozens of works doing RL with LMs on molecules, none of them do that within the LLM paradigm and none of them consider target-conditioned RL problem. The latter is primarily because pocket-conditioned generation is not possible without large-scale pretraining as shown herein.

The protocol can apply the REINFORCE algorithm (Williams, 1992) for further model finetuning. It allows to use the feedback (called reward) from an external oracle to train the model to generate even better structures compared to the ones it generates after the supervised finetuning (SFT) stage. The resulting RL-finetuned model can generalize model and produce high affinity molecules even for the new pockets. In the procedure, on each training step the protocol generates 3D structures of ligands for a batch of random protein pockets. Then the protocol computes the reward using an external docking software that estimates the binding energy between the pocket and the generated ligand. The final step involves updating the language model with the batch of prompts (pockets), responses (ligands), and rewards (binding energies). Previous studies initially tested PPO (Schulman et al., 2017) and REINVENT (Olivecrona et al., 2017), but found REINFORCE to be more stable for the present protocol and model, which aligns with another recent finding in the field of RL applied to language models in NLP (Ahmadian et al., 2024). In some aspects, the protocol applies the KL-penalty between the model's initialized and current state to stabilize the procedure.

### Pretraining

To achieve efficient pretraining, the protocol uses large batch training (Keskar et al., 2017) with 1.6M (1.6 million) tokens per batch. The protocol sets the microbatch size to the maximal that fits to the GPU memory and gradient accumulation is performed to get a large enough batch size (e.g., to eventually have 1.6M tokens per batch). Since training sequences have variable length that comes from the fact that molecules have different sizes, only a part of tokens contribute to the loss so as to have at least 1.6M such “enabled” tokens. The protocol uses learning rate warmup of 2000 steps, followed by cosine annealing of the learning rate. The maximal learning rate during pretraining is 10⁻³ regardless of the model size. It has been found that this many tokens per batch to be important for stable training in this task even with smaller learning rates, especially for models larger than 100M (100 million) parameters. The protocol uses AdamW optimizer (Loshchilov & Hutter,2019) with a weight decay factor of 10⁻². The protocol uses gradient clipping with the maximal grad norm of 1.0. The pretraining takes around 55 k (55 thousand) optimization steps over 36 hours on one compute node with 8 A6000 GPUs. The protocol uses Flash-Attention2 Dao (2023) and DeepSpeed optimization accelerator. To use more performant tensor cores, the protocol can train the model with mixed precision where computation is done within brain floating point 16-bit datatype (e.g., bfloat16 datatype). As the distributed optimizer, the protocol uses DeepSpeed ZeRO Stage-3 optimizer (Rajbhandari et al., 2020). The protocol trains the model for 1 epoch only. The amount of tokens in the dataset is 42B (42 billion) for the version without explicit hydrogens and 90B (90 billion) tokens for the version with explicit hydrogens. The total size of the Uni-Mol pretraining dataset is around 150 GB (150 gigabytes).

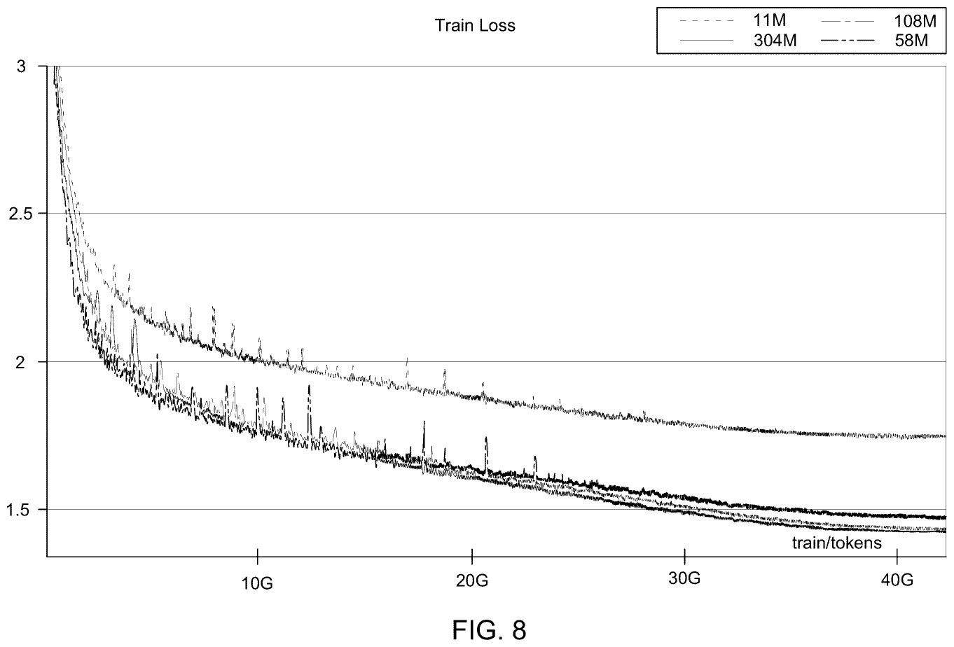

FIG. 8 shows a graph of data for Pretraining loss curves for different model sizes for the representation without explicit hydrogens.

### Supervised Finetuning

The supervised finetuning can use the public CrossDocked version v1.3, and for each molecule (except the ones optimized by the Gnina model (McNutt et al., 2021) as it yields too many bad intermediate samples) the protocol takes its “minimized” and “docked” formats and extracts all intermediate molecules from their files. For each such molecule, the protocol can cut the pocket with the ProDy (Bakan et al., 2011) tool. As a result of this process, the protocol obtain around 27M (27 million) pocket-ligand pairs. The size of the CrossDocked that is used is around 50 GB (50 gigabytes).

The supervised finetuning protocol can use the same recipe for finetuning as for the pretraining with a few changes in hyperparameters. In particular, the protocol uses a maximal learning rate of 5×10⁻⁴ and only 100 warmup steps. The learning rate schedule, weight decay, optimizer, maximal gradient norm are the same as for the pretraining. The only substantial difference from the pretraining stage is the weighted loss which is used for the CrossDocked finetuning. Specifically, the protocol weighs tokens that correspond to different parts of the output, differently. For example, the SMILES tokens have the weight of 1 while tokens that correspond to the XYZ coordinates placed after SMILES have the weight of 5. The tokens corresponding to the pocket have the weight of 0 since they are used as the context only and the protocol does not intend to generate them. The protocol performs a SMILES randomization (see Bjerrum (2017) for implementation details), and rotates the ligand (e.g., in the pocket) randomly. Briefly, the protocol can first sample a random 3D rotation vector, and convert it to a rotation matrix and apply it to the coordinates of both. Also, the protocol enforces the origin of their coordinates to be the same, namely, the coordinate center of the ligand (i.e. model will generate coordinates around the origin).

The protocol trains the model on the CrossDocked dataset for 1 epoch, and extracts the full version of the CrossDocked data.

For the finetuning on the GEOM-DRUGS dataset, the protocol uses the same hyperparameters as in the SFT stage for CrossDocked with only two differences. First, the protocol weights the loss for all tokens with the same weight of 1. Second, the protocol does not rotate 3D coordinates of the molecule, but does SMILES randomization.

### Reinforcement Learning Finetuning

The last stage of the protocol (e.g., process pipeline) is reinforcement learning. The protocol can use a distributed reinforcement learning algorithm based on the TRL (von Werra et al. 2020) training loop. In some embodiments, the protocol is performed by launching multiple GPU processing systems, where each repeated samples experiences, computes rewards, computes the update for the policy (i.e., the transformer language model), synchronizes them, and then performs the gradient update. The system can include at least 8 GPU processing systems (e.g., gpu workers), each with the local batch size of 16. At every step, the protocol samples a batch of pockets, samples molecules for them, then computes the rewards via a docking tool. The protocol can then perform only one gradient update. In some aspects, each step can include in sequence: sample a batch of pockets, sample molecules for the batch of pockets, then compute the rewards via a docking tool, and perform only one gradient update, which can inhibit the training from diverging. Even algorithms that are believed to be more powerful, such as PPO (Schulman et al., 2017), experience instabilities when the policy lag is bigger. The surrogate loss for reinforcement learning has the following form:

$$L ( θ , s , a ) = - R ( s , a ) 1 / \vert a \vert * log p θ ( a \vert s ) + α KL ( p θ 0 ( \cdot \vert s ) ‖ p θ ( \cdot \vert s ) )$$

Here s is the tokenized representation of the pocket and α is the tokenized representation of the generated molecule. The p_{θ} is the current version of the language model being finetuned while p_{θ0} is the result of the SFT stage. R(s, α) is the vina score computed for the corresponding pocket-molecule pair. Finally, the protocol computes the distillation style KL because it can be beneficial to keep the output distribution of the RL model wide. The KL weight a in the experiments is α=0.05. The protocol uses a flat learning rate of 1.4×10⁻⁵ and no weight decay. Like before, the protocol clips the gradient norm at 1.0. In the surrogate loss function, the log likelihood of the token sequence is averaged (instead of being summed), which can enhance training stability.

### EXPERIMENTAL

The 3D generative modeling of molecules and conformation generation can be performed with the trained model for a given molecular graph, and then perform pocket-conditioned generation. For pretraining, the protocol uses a large 3D molecular dataset proposed by the authors of the Uni-Mol model (Zhou et al., 2023). The dataset contains 208M (208 million) conformations for 12M (12 million) molecules and 3.2M (3.2 million) spatial structures of protein pockets. For finetuning, the protocol uses the aforementioned CrossDocked dataset which contains aligned pocket-molecule pairs. The filtration of the dataset has around 27M (27 million) pocket-ligand pairs covering a cross product of 14 k (14 thousand) molecules with 3 k (3 thousand) pockets (e.g., not all of the pairs are present, and for some of them, there is more than one pose, each with different score). The protocol also holds out a set of 100 pockets from the training data for evaluating the model performance. For a more fair comparison with baselines, the protocol can finetune the model on the GEOM-DRUGS (Axelrod & Gomez-Bombarelli, 2022) dataset, with drug-like molecules having high-quality 3D molecular conformations. This dataset contains 27M (27 million) conformations for 300 k (300 thousand) molecules, and it serves as a standard benchmark for the machine learning-based 3D molecular generators.

Finally, the protocol uses the Platinum (Friedrich et al., 2017) dataset as a hold-out evaluation dataset to test the trained model and baselines on zero-shot conformer generation. Platinum dataset contains the best-in-class experimentally validated conformations for testing conformer generation software.

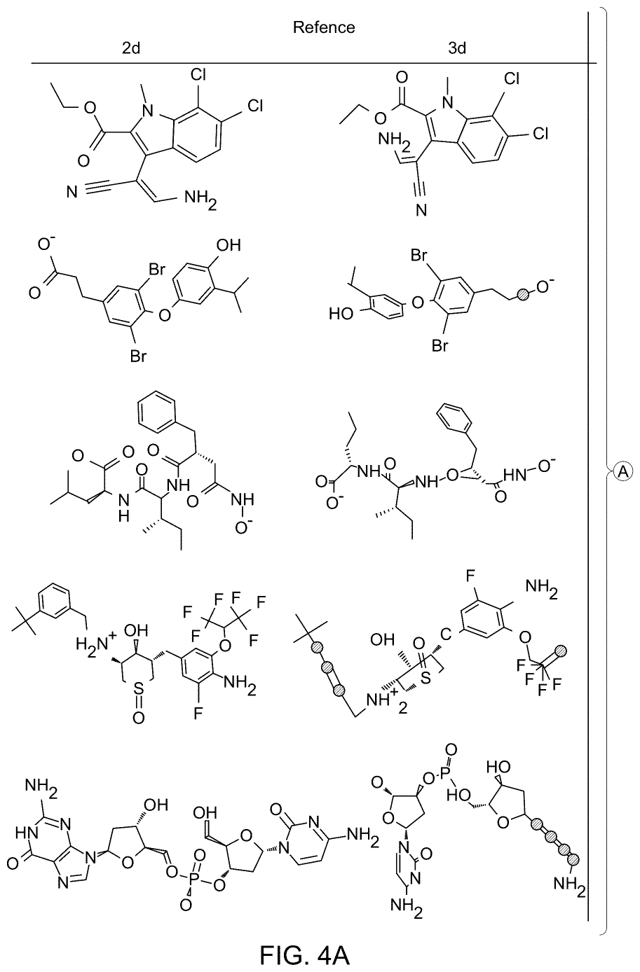

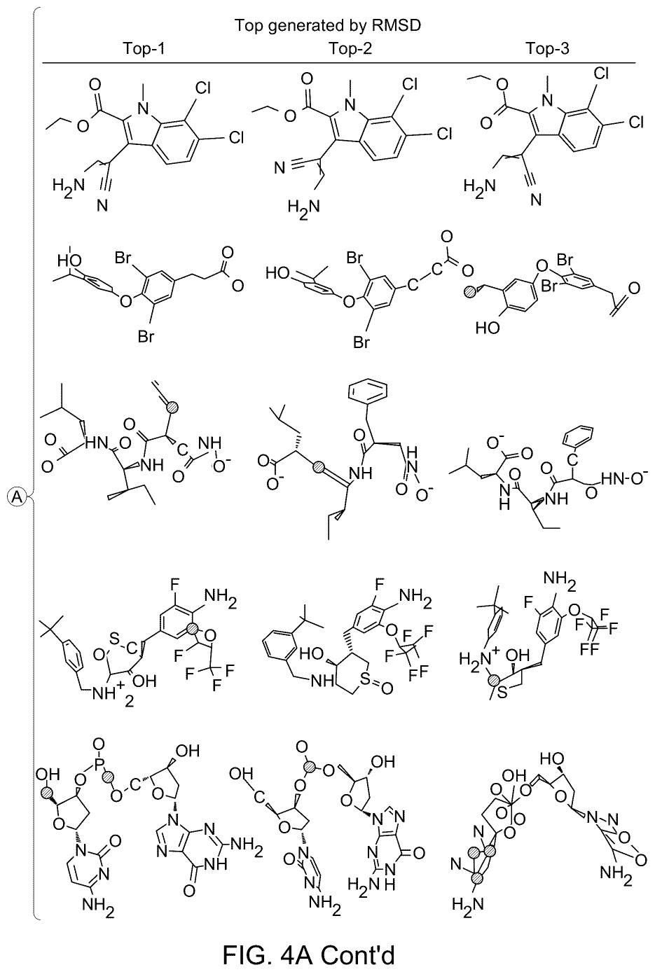

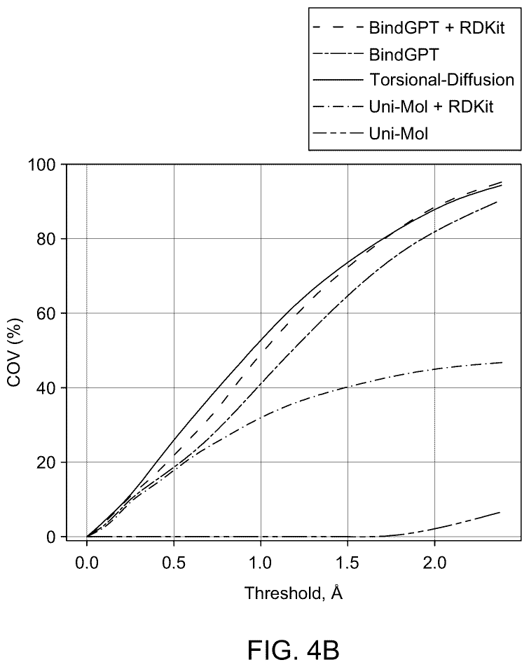

See FIGS. 4A and 4B. FIG. 4A shows the sampled confirmations for reference molecules from the Platinum dataset. FIG. 4B shows the RMSD coverage metric calculated on the Platinum dataset for the 3D conformation generation task.

Table 1 shows the data for the generative metrics for the molecule generation task after the pretraining. The (H) is explicit hydrogens are generated with molecules. For XYZ-TF, the RMSD calculation algorithm failed to converge.

TABLE 1
Generative Modeling of 3D Molecules.

| Method | Valid (↑) | SA (↑) | QED (↑) | Lipinski (↑) | RMSD (↓) | Time, s (↓) |
|---|---|---|---|---|---|---|
| XYZ-TF | 12.87% | 0.21 | 0.30 | 4.79 | | 65 |
| BindGPT (Ours) | 98.58% | 0.77 | 0.59 | 4.86 | 0.89 | 13 |
| XYZ-TF (H) | 17.86% | 0.54 | 0.37 | 4.82 | | 394 |
| BindGPT (H) (Ours) | 77.33% | 0.78 | 0.61 | 4.91 | 3.44 | 156 |

### Metrics for Generative Modeling of 3D Molecules

Studies are performed to provide the validity increase (⬆) of generated molecules and drug likeness metrics. The SA increase (⬆), QED increase (⬆), and Lipinski increase (⬆) that are agnostic to 3D but measure how likely the molecule is to be a drug. Also, the protocol can adopt a range of distribution metrics that were used for the MolDiff method (Peng et al., 2023a). Those metrics measure the discrepancy between true and modelled molecular distributions by computing the Jensen-Shannon divergences on the set of molecular properties and features distributions. The protocol can compute RMSD (RootMean-Squared-Distance) decrease (⬇)—which measures the quality of 3D structures by aligning the generated one with the one from RDkit (i.e., regenerate conformer via RDkit) and computing the atomwise distance. Finally, the time is measured that is needed to generate 1K (1000) valid 3D molecules on one GPU. Note that this choice of metrics is standard for this task (see Peng et al. (2023a)). For the 3D conformation generation given molecule task, we compute the RMSD-coverage increase (⬆) metric. This is a standard performance metric for 3D conformer generation models (see e.g. Jing et al. (2022)). It is represented by the cumulative distribution function of RMSD between generated and reference conformers. The metric is a function of the threshold x: P(RMSD<x). An ideal model should have as high metric value as possible for as low thresholds as possible.

### Baselines

For the molecule generation task, the protocol considers the current best 3D generative models. EDM (Hoogeboom et al., 2022) and MolDiff (Peng et al., 2023a) are task-specialized diffusion models for 3D molecule generation. XYZ-Transformer (Flam-Shepherd & AspuruGuzik, 2023) is another 3D molecular transformer that was proposed for small-scale data. Note that XYZ-TF is the only model capable of large scale pretraining besides our model, so the protocol can pretrain only XYZ-TF and BindGPT on Uni-Mol. The GEOM-DRUGS evaluation can also be performed, where MolDiff and EDM are trained on the full dataset and for BindGPT finetuned on the same version of the full dataset. For conformer generation, the protocol compares BindGPT with the current state-of-the-art methods, Torsional Diffusion Jing et al. (2022) and the Uni-Mol model (Zhou et al., 2023). The former is a specialized SE(3)-equivariant diffusion model capable of conformation generation only. The latter is a modified BERT (Devlin et al., 2019). As a coordinate-level encoder LM, Uni-Mol needs input coordinates to generate a conformation, which is why this model uses RDKit as a tool for initializing coordinates.

TABLE 2
The qualities of the generated 3D molecules after training on GEOM-DRUGS.

| | | | | BindGPT |
|---|---|---|---|---|
| Group | Metrics | EDM | MolDiff | (Ours) |
| Drug | QED (↑) SA (↑) | 0.558 | 0.668 | 0.616 |
| likeness | | 0.568 | 0.874 | 0.826 |
| | Lipinski (↑) | 4.923 | 4.986 | 4.896 |
| 3D | JS. bond lengths (↓) JS. | 0.246 | 0.365 | 0.029 |
| structures | bond angles (↓) | 0.282 | 0.155 | 0.075 |
| | JS. dihedral angles (↓) | 0.328 | 0.162 | 0.098 |
| Bonds | JS. num. bonds per atoms (↓) | 0.139 | 0.115 | 0.16 |
| | JS. freq. bond types (↓) JS. | 0.378 | 0.163 | 0.045 |
| | freq. bond pairs (↓) | 0.396 | 0.136 | 0.043 |
| | JS. freq. bond triplets (↓) | 0.449 | 0.125 | 0.0423 |
| Rings | JS. num. rings (↓) JS. num. | 0.106 | 0.062 | 0.094 |
| | n-sized rings (↓) | 0.107 | 0.092 | 0.023 |
| | Num. Intersecting rings (↑) | 3.667 | 8.000 | 9.000 |
| | Time for 1000 valid molecules, | 1.4 × 10⁶ | 7500 | 200 |
| | s (↓) | | | |

### Results

The molecular generative modeling results are shown in Tables 1 and 2. First, the pretrained BindGPT model consistently outperforms the XYZ-TF baseline both without and with explicit hydrogens. The latter is a much more challenging task and almost no baseline methods can do that (except EDM, which is not scalable) since reconstructing hydrogens can be done on a post-processing step but explicit modeling of them makes the molecule size several times larger. BindGPT is the first model capable of modeling hydrogen explicitly at such large scale. Also, XYZ-TF has a very low validity rate due to the need of graph reconstruction. Next, for the methods trained on the GEOM-DRUGS dataset, BindGPT (being finetuned on this data) shows state-of-the-art performance scores for nearly all distributional evaluation metrics. Even though BindGPT does not outperform MolDiff in Druglikeness, that could be explained by a smaller vocabulary of the (Peng et al., 2023a), containing only frequent atoms. For the conformation generation task, the current best baseline is Torsional Diffusion (TD) (Jing et al., 2022). The experiment used the Platinum dataset to compare TD trained on GEOM-DRUGS with Uni-Mol-BERT and BindGPT, both of which are pretrained and finetuned on the same data. FIG. 4B shows the results for zero-shot evaluations on Platinum. Surprisingly, Uni-Mol fails to generalize to this new dataset (even assisted by RDKit), which is thought to be because of its structural diversity. BindGPT, in contrast, is capable of matching the performance of TD when assisted by the RDKit tool and having a small gap when not. All the above results demonstrate the ability of the trained BindGPT model to provide wide performance metrics, which is compared to none of the baselines being able to solve this wide range of task at this level of quality.

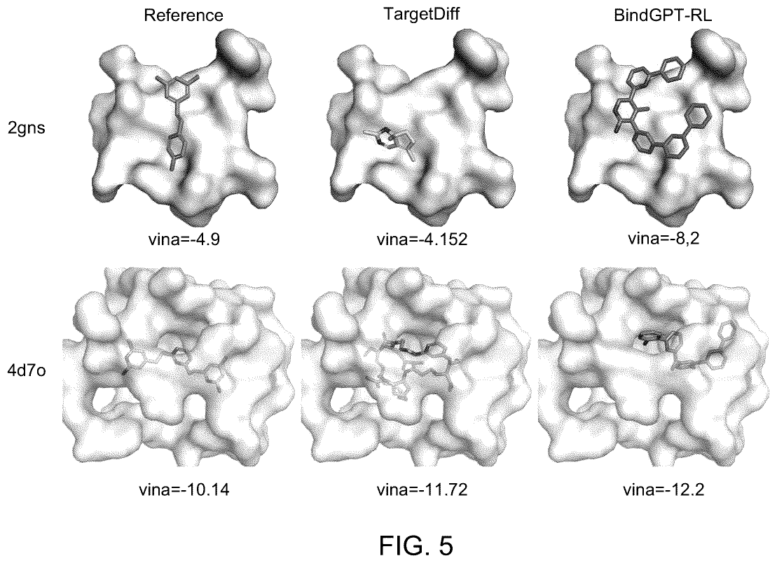

See FIG. 5, which shows some examples of binding poses and Vina scores (⬇) for 2 gns and 4d7o pockets.

### Metrics for Pocket-Conditioned Molecule Generation

The main metrics for this task include the measure of ligand-pocket affinity; and drug likeness of the ligand. The first one is represented via the binding energy decreasing (⬇) as computed by the QVINA (Alhossary et al., 2015) docking software, while the second one comprises the aforementioned drug likeness metrics, such as synthetic accessibility (SA) increasing (⬆), quantitative estimation of drug likeness (QED) increasing (⬆), and Lipinsky (e.g., Lipinsky rule of five for drug likeness) increasing (⬆). For each baseline, the system reports the time required to generate 100 valid molecules for one pocket in a protocol.

### Baselines

In order assess the functionality of the BindGPT model described herein is compared to the baseline models including 3D diffusion models (TargetDiff (Guan et al., 2023)), autoregressive Graph Neural Network (Pocket2Mol (Peng et al., 2022)), small-scale downstream fragment-level language model (Lingo3DMol (Feng et al., 2024)). Note that none of the baseline models perform large-scale pretraining. Instead, the baseline models resort to heavy inductive biases to efficiently learn from small-scale data.

### Results

Performance of the models in the study is summarized in Table 3. The performance of three version of BindGPT are shown. First, BindGPT-FT is a model finetuned on the complete CrossDocked data, such as with both good and bad binding pairs. This model serves as an initialization for the reinforcement learning model. Second, BindGPT-RFT is the model finetuned on CrossDocked with the reward in the context. To get higher affinity molecules from that model, the protocol conditions the model on random binding energy values within [−12, −10], which are the best scores observed by the model (in around 0.1% of examples). Finally, the BindGPT-RL model is trained with RL from the BindGPT-FT initialization. The main conclusion is that the RL finetuned model can learn to search the space of binding molecules much more efficiently and significantly outperforms all the previous best baselines in terms of the binding energy.

TABLE 3
Generative metrics for the pocket-conditioned generation task

| Method | Vina score (↓) | SA (↑) | QED (↑) | Lipinski (↑) |
|---|---|---|---|---|
| Pocket2Mol | −7.15 ± 4.89 | 0.75 ± 0.12 | 0.57 ± 0.15 | |
| | | | 4.88 ± 0.37 | |
| TargetDiff | −7.80 ± 3.61 | 0.58 ± 0.12 | 0.48 ± 0.19 | 4.51 ± 0.85 |
| BindGPT-FT | −5.44 ± 2.09 | 0.78 ± 0.10 | 0.50 ± 0.17 | 4.72 ± 0.70 |
| BindGPT-RFT | −7.24 ± 1.68 | 0.74 ± 0.11 | 0.48 ± 0.22 | 4.32 ± 1.25 |
| BindGPT-RL | −8.60 ± 1.90 | 0.84 ± 0.05 | 0.43 ± 0.17 | 4.81 ± 0.52 |

The data provided herein shows that the BindGPT model is a scalable framework for training capable language models that can generate 3D molecules as text. Through a series of studies on a range of different 3D molecular generative tasks, the data demonstrate the protocol implemented with BindGPT can solve each of them by matching or surpassing the baselines. Notably, the BingGPT protocols do not have any inductive biases about the generative domain acting as a general and data-driven approach. Unlike all the baselines which have strong inductive biases, out method solves each downstream task without any such assumptions. The task of a particular interest is the pocket-based molecule generation where the BingGPT model outperforms all the baselines by a large margin. The data show that the large-scale pretraining paradigm can be efficiently transferred from NLP to the 3D drug discovery.

### Evaluating Pretraining

The protocol can include performing a pretrain operation on the BingGPT model on 208M (208 million) 3D conformations of molecules. By experimenting with different models size, it is observed that the model scales well up until the size of 300M (300 million) parameters, where its perplexity shows overfitting. Therefore, the protocols may be performed with the 100M (100 million) model in the later experiments as it was found to yield the best results. ZINC-250 k for sizes 11M (11 million), 58M (58 million), 108M (108 million), 304M (304 million). Note that high value of perplexity is dictated by the highly stochastic nature of 3D molecule coordinates. It is thought that the model quality can be improved further by increasing the amount of the data for pretraining and the current 108M (108 million) model obtains the best performance given the pretraining dataset.

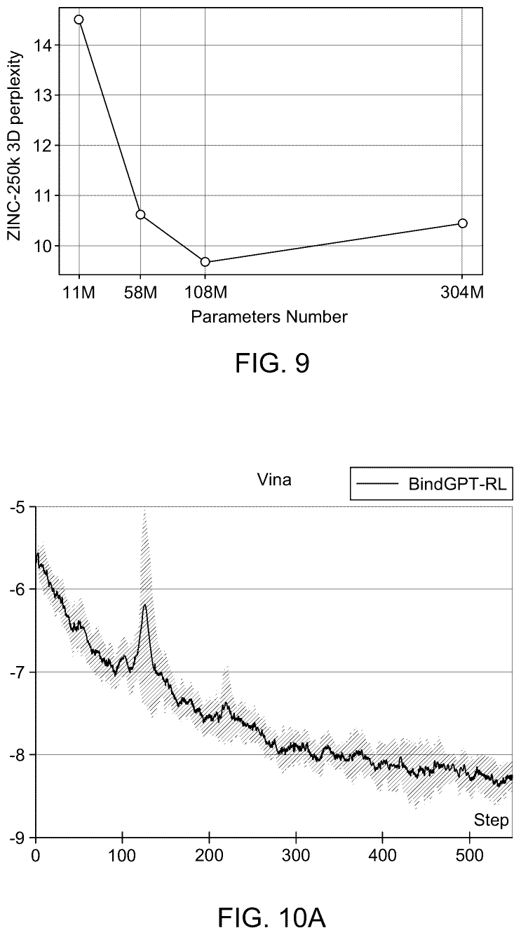

FIG. 9 includes a graph that shows the test perplexity on the holdout Zinc-250 k dataset with 3D conformations from RDKit. BindGPT is the first model capable of this type of evaluation.

### Reinforced Learning Finetuning Training Curves

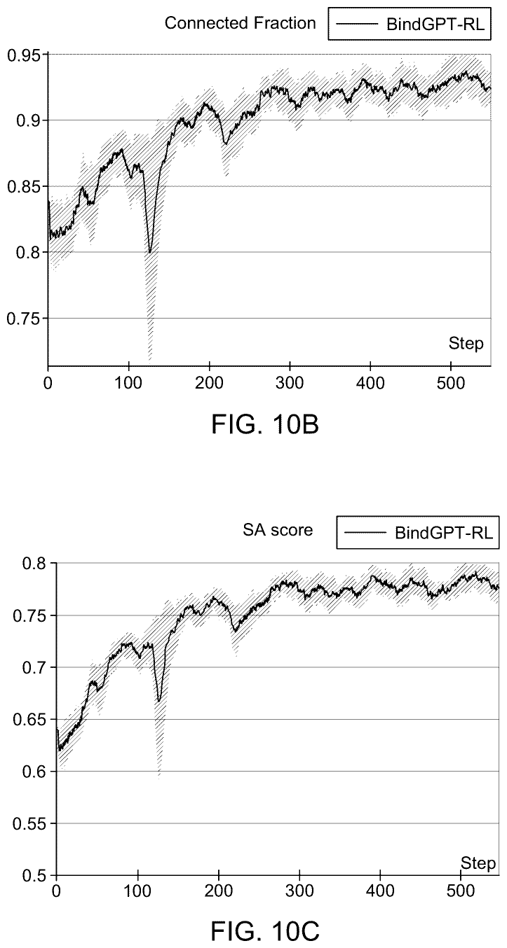

FIGS. 10A-10C includes a graph of data that shows the ligand-pocket affinity objectives averaged over several runs for RL finetuning stage: (FIG. 10A) Vina Score; (FIG. 10B) Ligand connectivity; and (FIG. 10C) Synthetic Accessibility.

Samples from BindGPT Model

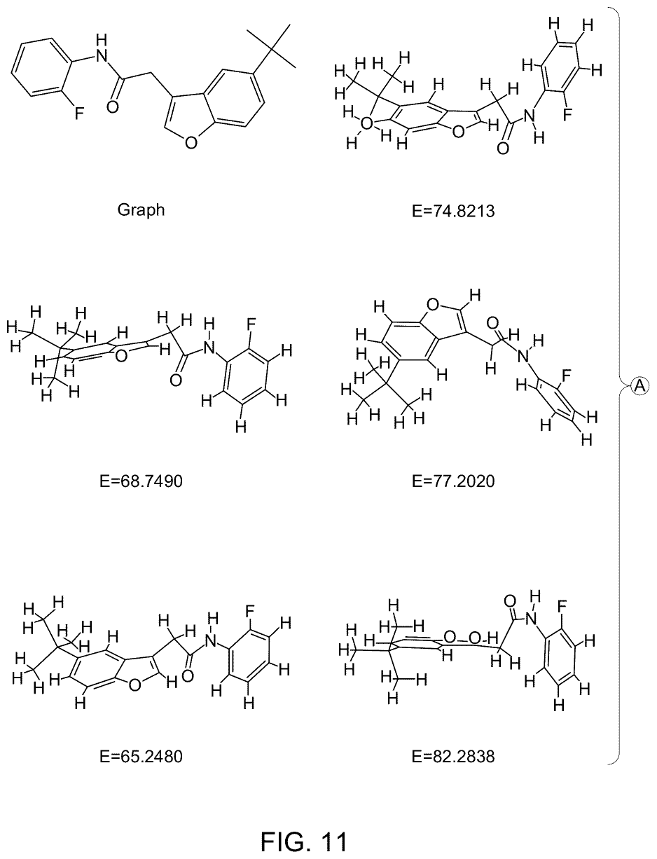

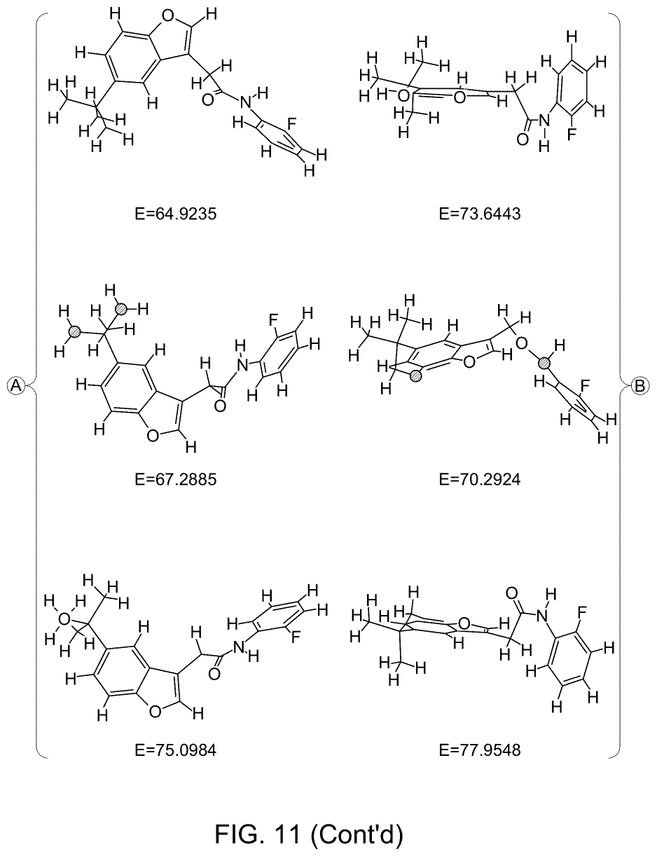

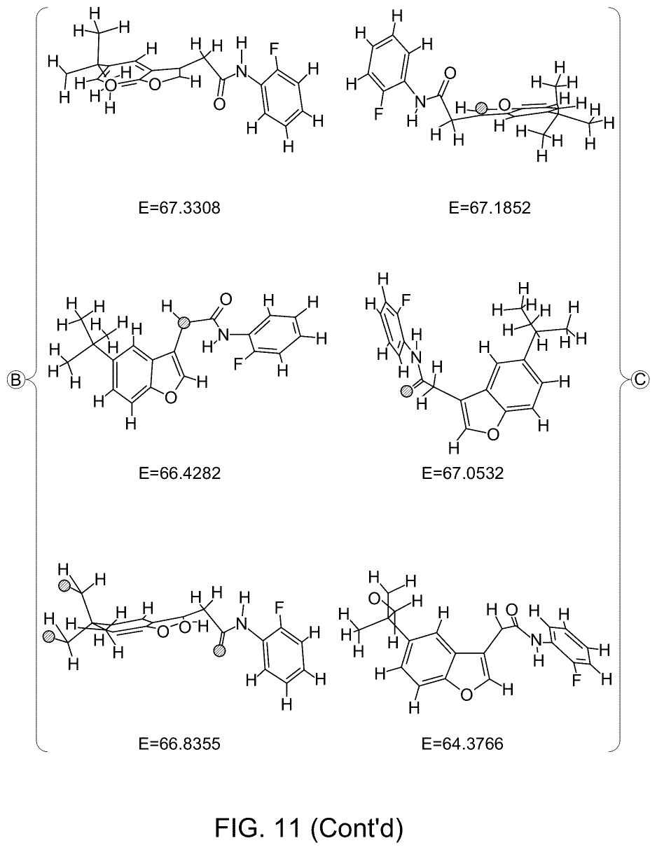

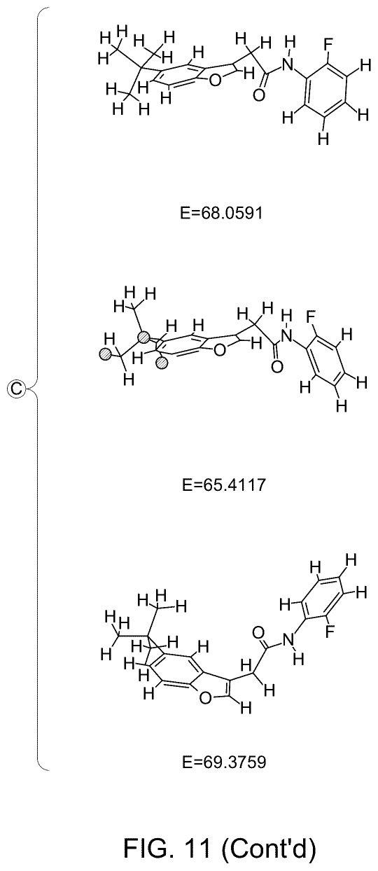

FIG. 11 shows the 3D conformations generated by BindGPT with explicit hydrogens for a fixed molecule graph. No assistance tools are used. Also, no manual cherry-picking is used here.

### Augmented BindGPT Model

For the unconditional molecule generation tasks and the conformation generation tasks, the protocol enhances the 3D generative abilities of the BindGPT model though the use of the RDKit tool. However, it is used only as a scoring mechanism while the model still acts as the proposal distribution. The scoring happens in the following way: first, the protocol generate a SMILES string only (skip this step if needing to do the conformation generation task). Then, generate N different conformations from the BindGPT model and score each confirmation with the MMFF (Halgren, 1996) energy from RDKit. After that, the generated conformation with minimal energy is selected and returned as a sample. This generated conformation can then be validated for having binding with the target protein. In this study, MMFF is not used to optimize the conformation, and the model is not provided with any information about the 3D structure. That is, for example, the BindGPT, finetuned on the GEOM-DRUGS will still generate samples within the GEOM conformation distribution (which is different from the distribution produced by MMFF) as can be seen in Table 2. In addition, when comparing with even higher quality, real world-like conformations, such as the ones of the Platinum dataset, the assisted generation boosts the performance of the model (as can be seen in FIG. 4B). This indicates that the generated distribution of 3D structures is close to the real world conformations, despite MMFF being just a theoretical approximation. This confirms that such a selection process describes above does not bias the distribution of models outputs, but rather helps it to eliminate generation errors (e.g. atom misplacements). Notably, the protocols do not use the assisted generation for the protein-ligand binding task. The experiments use N=10, but this number could vary.

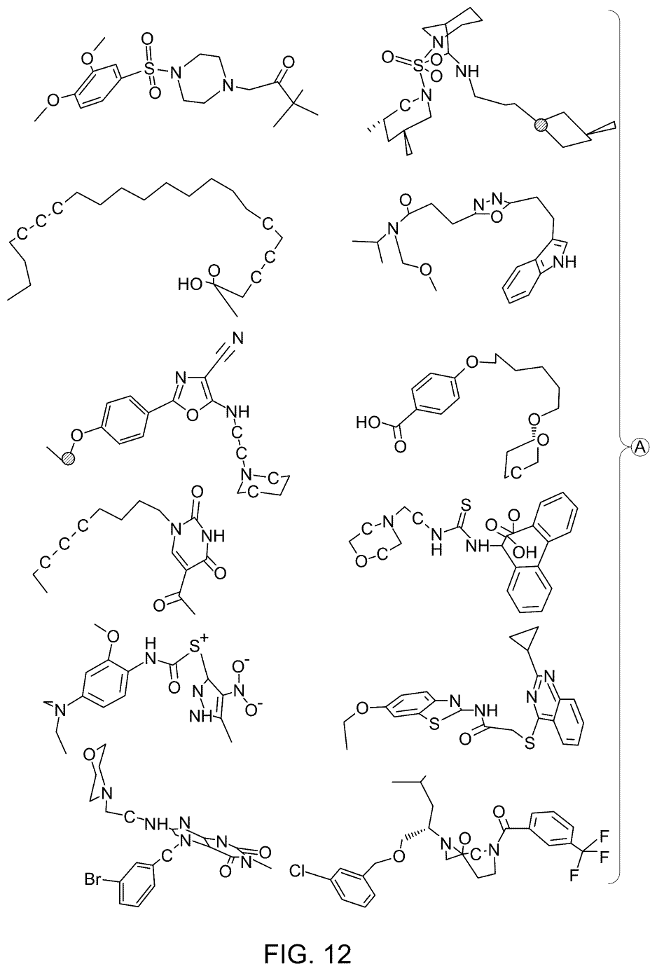

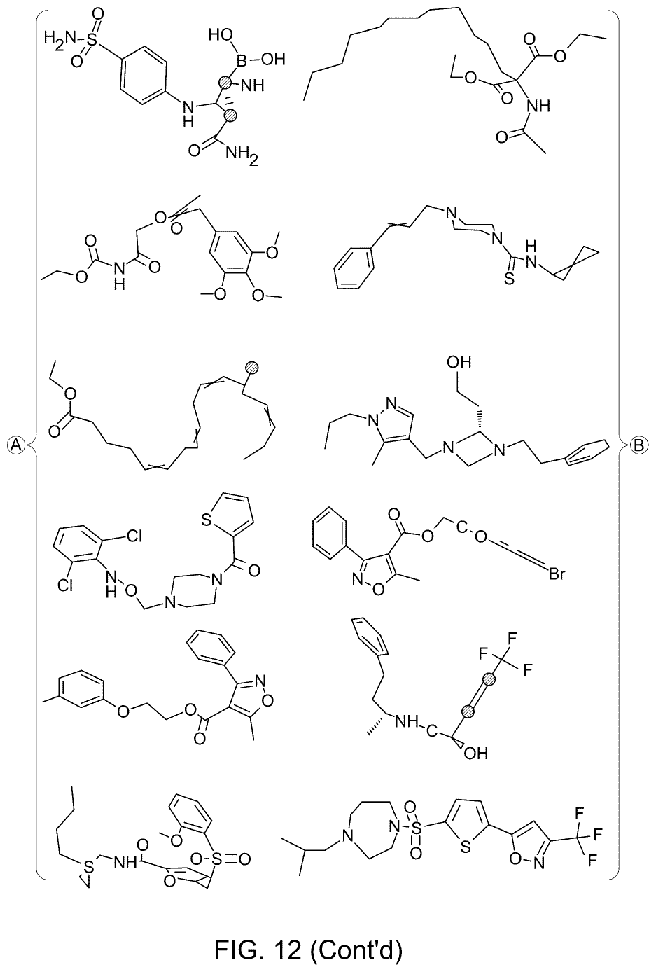

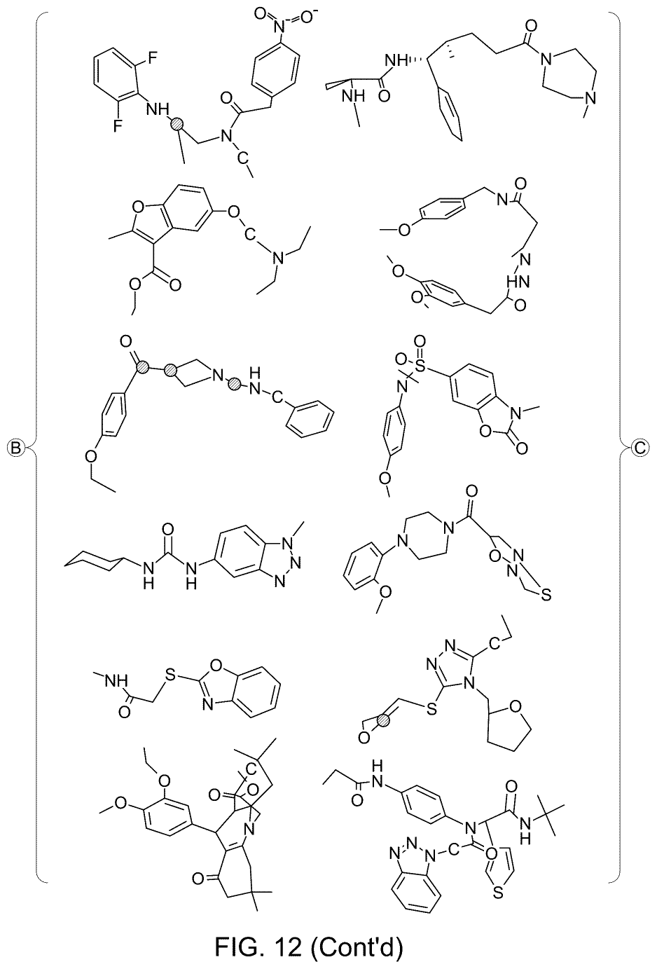

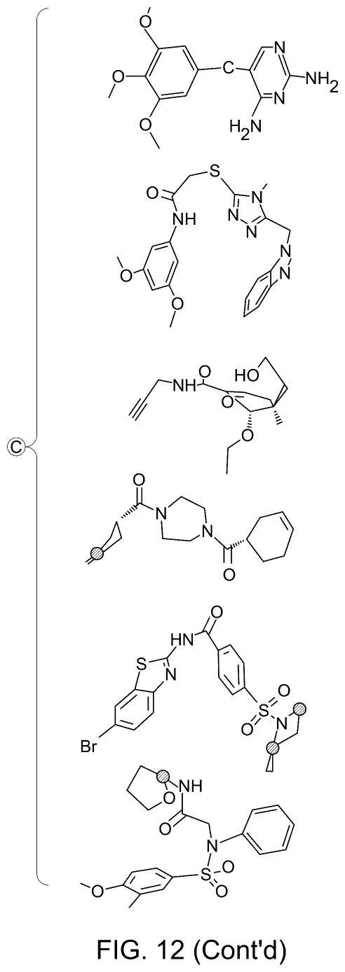

FIG. 12 shows examples of generated molecules sampled from the BindGPT model without condition.

### Training and Inference

Despite the wide use of transformers in drug discovery, the majority of current works in this space do not use recent technical advancements that make LLMs efficient, such as Flash Attention (Dao, 2023). The reason is because the pretraining paradigm is still coming to drug discovery, with perhaps only one example of Uni-Mol (Zhou et al., 2023) being a multi-task pre-trained transformer model, which unlike this work uses an Encoder-only model that follows the BERT (Devlin et al., 2019) architecture. Therefore, small models are simply trained directly on downstream datasets for which training time optimizations are not crucial. For the case of pretraining, even for a small model, the pretraining over 90B (90 billion) tokens can take a significant time but it obtains a speedup of almost 3 times as a result of just using a combination of Flash Attention (Dao et al., 2022; Dao, 2023) and DeepSpeed (Rasley et al., 2020).

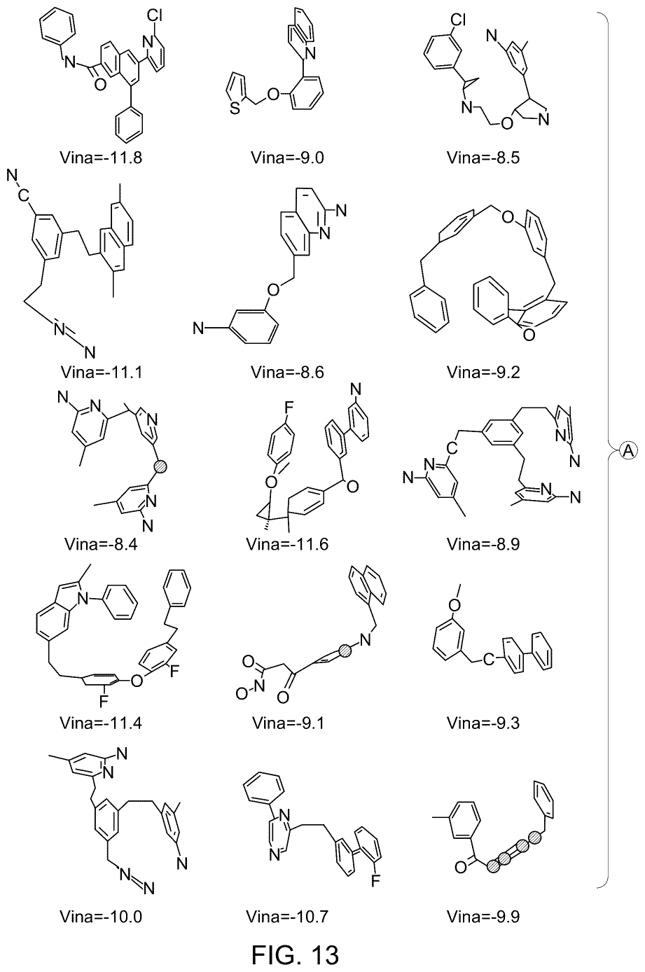

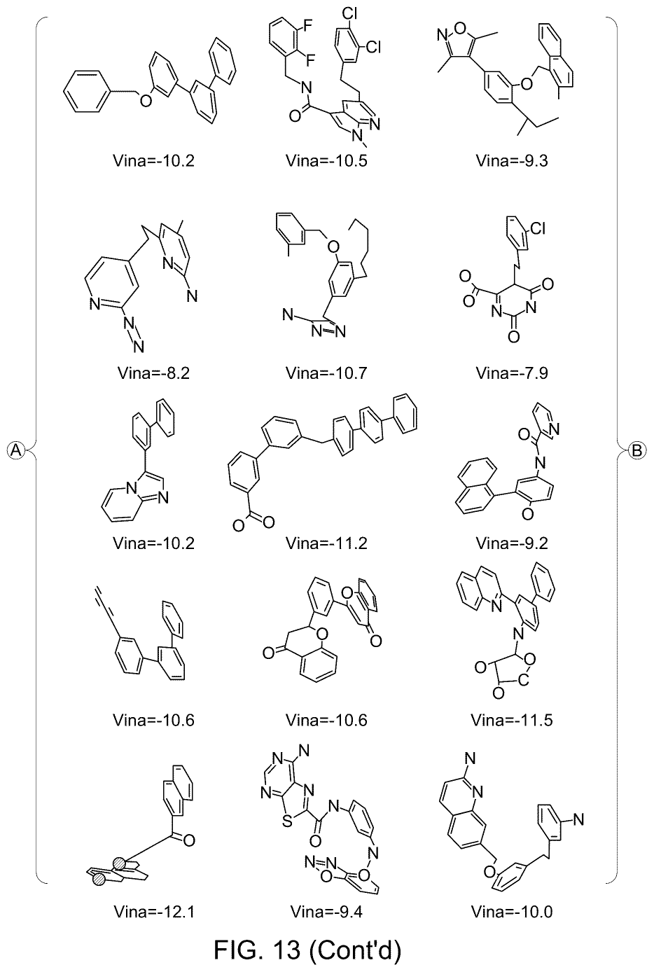

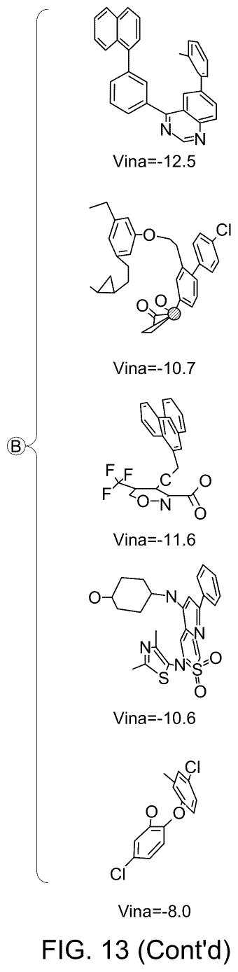

FIG. 13 shows examples of generated molecules for 4d7o pocket after the RL-finetuning. Note that no cherry picking (or other filtering) was performed and these are just the first 35 model samples.

To facilitate efficient training and inference, the protocol can use the transformers (Wolf et al., 2020) library from Hugginface with the PyTorch framework (Paszke et al., 2019). The example training used Flash Attention 2 (Dao, 2023) implementation of self-attention, and the DeepSpeed (Rasley et al., 2020) distributed training framework. During autoregressive sampling, Key-Value caching and Flash Attention 2 is used to speed up decoding. Despite being just implementation optimization tricks, these two techniques can make a big difference for sampling as they speed up decoding by two orders of magnitude compared to the naive approach, making sampling with transformer decoders significantly faster compared to the sampling from diffusion models. For example, KV-caching reuses past attention keys and values resulting in O(1) MLP forward passes instead of O(L) at each decoding step, where L is the prefix length. Thus, the total number of forward passes with decoding length L is O(L) instead of O(L²).

In some embodiments, the object is a molecule, such as a small molecule, macromolecule, polypeptide, protein, antibody, oligonucleotide, nucleic acid (e.g., RNA, DNA, etc.), polypeptide, carbohydrate, lipid, or combinations thereof, whether natural or synthetic.

In some embodiments, the molecules of the generated object data from the decoder are analyzed, and one or more specific molecules that fit the condition criteria are selected. The selected one or more molecules are then selected and synthesized before being tested with one or more cells to determine whether or not the synthesized molecules actually satisfy the condition.

The selected molecule is then provided to an object synthesizer, where the selected object (e.g., selected molecule) is then synthesized. The synthesized object (e.g., molecule) is then provided to the object validator (e.g., molecule validator, which tests the object to see if it satisfies the condition or property, or to see if it is biologically active for a specific use. For example, a synthesized object that is a molecule can be tested with live cell cultures or other validation techniques in order to validate that the synthesized molecule satisfies the desired property. Once a generated object is selected, then the method includes validating the selected object. The validation can be performed as described herein. When the object is a molecule, the validation can include synthesis and then testing with live cells.

In some embodiments, a method can include selecting a selected object (e.g., molecule with 3D conformation that binds pocket of target protein) that corresponds with the selected generated object data or that corresponds with the desired properties; and validating the selected object.

In some embodiments, the method may include: obtaining a physical object for the selected object (e.g., synthesize); and testing the physical object to have a desired property or biological activity. Also, in any method, the obtaining of the physical object can include at least one of synthesizing, purchasing, extracting, refining, deriving, or otherwise obtaining the physical object of the molecule. The physical object may be a molecule or other suitable object that can bind with the protein pocket. The methods may include the testing involving assaying the physical object in a cell culture or other assay to detect binding of the physical object to a physical form of the target protein pocket. The methods may also include assaying the physical object by genotyping, transcriptome-typing, 3-D mapping, ligand-receptor docking, before and after perturbations, initial state analysis, final state analysis, or combinations thereof. Preparing the physical object for the selected generated object can often include synthesis when the physical object is a new molecular entity.

In some embodiments, the method can include: preparing the physical form of the selected object (e.g., molecule); and testing the physical object with the condition (e.g., molecule binding with target protein pocket).

In some embodiments, the method can include: the obtaining of the physical form of the selected object includes at least one of synthesizing, purchasing, extracting, refining, deriving, or otherwise obtaining the physical object; and/or the testing includes assaying the physical form of the selected object in a cell culture; and/or assaying the physical form of the selected object by genotyping, transcriptome-typing, 3-D mapping, ligand-receptor docking, before and after perturbations, initial state analysis, final state analysis, or combinations thereof.

In some embodiments, the method can include determining whether the molecule satisfies the condition by having a desired property, such as a specific biological activity.

### Embodiments

Embodiment 1. A computer-implemented method comprising: inputting into a computing system a neural network-based language model for generating a 3D structure of a molecule conditioned by atomic connectivity or a binding of the molecule with a target protein pocket; inputting large-scale training data into the computing system, which includes a 3D structure of a molecule, a target protein pocket, or a binding of the molecule with the target protein pocket; training the language model with the large-scale training data set to obtain a pre-trained language model, wherein the pre-trained language model is trained to generate the 3D structures of molecules and/or protein pockets; inputting finetuning training data into the computing system regarding a second set of a binding of the molecule with the target protein pocket; training the pre-trained language model with the finetuning training data to obtain a finetuned language model capable of at least one of: generating 3D structures of molecules capable of binding to the target protein pockets or generating 3D structures of molecules bound in the target protein pockets or generating 3D structures of the target protein pockets; performing reinforcement learning training with the finetuned language model to obtain a trained model of the 3D structure, wherein the reinforcement learning data includes random rotations to protein pocket coordinates of the target protein pocket; and providing the trained language model capable of generating the 3D structure of at least one generated molecule that fits into the target protein pocket, or a 3D structure of the generated molecule defined by atomic connectivity that fits into the target protein pocket, or a 3D structure of the generated molecule without specific binding.

Embodiment 2. The computer-implemented method of embodiment 1, further comprising representing the 3D structure as a textual representation.

Embodiment 3. The computer-implemented method of embodiment 3, further comprising the textual representation including a token scheme to encode 3D spatial data into a sequence of tokens.

Embodiment 4. The computer-implemented method of embodiment 1, further comprising performing a training-time data augmentation procedure to increase accuracy of 3D structure generation when the training set lacks sufficient 3D coordinate data.

Embodiment 5. The computer-implemented method of embodiment 1, further comprising representing 3D molecular structures as: a molecular structure text that starts with a <LIGAND> token followed by a SMILES string, wherein SMILES is a textual encoding of a depth-first pass applied to a molecular graph of a molecule, wherein the SMILES string encodes connectivity between atoms, wherein the SMILES is tokenized so that each atomic symbol has its own token.

Embodiment 6. The computer-implemented method of embodiment 1, further comprising representing spatial information of the 3D molecular structure by: generating a molecular structure text with a <XYZ> special token marking an end of a SMILES string, each next line of text is a triplet of X, Y, Z coordinates, an order of the X, Y, Z coordinates corresponds to an order of atoms in the SMILES string; performing a tokenizing of the X, Y, Z coordinates by assigning: one token to each integer part with a possible sign; another token to a 3-digit fractional part including a dot; and obtaining 6 tokens per each 3D position of the 3D structure.

Embodiment 7. The computer-implemented method of embodiment 1, further comprising representing 3D structure as protein pocket structures as: a protein pocket structure text starts with a <POCKET> special token followed by a sequence of atomic symbols, wherein the sequence of atomic symbols is a textual encoding of protein pocket, wherein the sequence of atomic symbols encodes amino acid sequence, wherein each atomic symbol gets its own token.

Embodiment 8. The computer-implemented method of embodiment 1, further comprising representing spatial information of the 3D structure: generate protein pocket structure text with a <XYZ> special token marking a beginning of spatial coordinate of the 3D structure, each next line of text is a triplet of X, Y, Z coordinates, an order of the X, Y, Z coordinates corresponds to an order of atoms in the pocket, for each coordinate: performing a tokenizing of the X, Y, Z coordinates by assigning: one token to each integer part with a possible sign; and another token to a 3-digit fractional part including a dot; and obtaining 6 tokens per each 3D position of the 3D structure.

Embodiment 9. The computer-implemented method of embodiment 1, wherein training of the trained language model of the 3D structure includes autoregressive objectives to predict each next token in an input of each 3D structure.

Embodiment 10. The computer-implemented method of embodiment 1, wherein in the training with the large-scale training data set, the language model is trained on pocket blocks and ligand blocks separately from each other, wherein the ligand blocks represent the molecular structure.

Embodiment 11. The computer-implemented method of embodiment 1, wherein in order to alleviate scarcity of 3D protein structures, the method up samples protein pockets in a 5 to 1 ratio to molecular structures as ligands for the protein pockets.

Embodiment 12. The computer-implemented method of embodiment 1, during the training of the pre-trained language model with a finetuning data set, further comprising training the pre-trained language model on combined strings which include the target protein pocket followed by a ligand.

Embodiment 13. The computer-implemented method of embodiment 1, comprising: randomizing SMILES strings of a molecular structure with a procedure choosing different depth-first passes of a molecular graph of the molecular structure during each training step, wherein a corresponding permutation is applied to the coordinate part.

Embodiment 14. The computer-implemented method of embodiment 1, comprising: applying random rotations to a generated protein pocket 3D structure and ligand coordinates of the 3D structure using a same rotation matrix.

Embodiment 15. A computer-implemented method of generating a molecule comprising: providing a target protein pocket for receiving the molecule; generating a series of molecules using text with the method of embodiment 1.

Embodiment 16. The computer-implemented method of embodiment 15, further comprising defining the target protein pocket to be of a protein of a disease, and determining the generated molecule to bind with the target protein pocket to inhibit the protein of the disease as a therapeutic for the disease.

Embodiment 17. A method of obtaining a molecule, further comprising: generating at least one generated molecule using text with the method of embodiment 1, wherein the at least one generated molecule binds with the target protein pocket; and obtaining a physical version of the at least one generated molecule.

Embodiment 18. The method of embodiment 17, further comprising: providing a physical version of the target protein pocket; introducing the physical version of the at least one generated molecule to the physical version of the defined protein pocket; and detecting binding between the physical version of at least one generated molecule and the physical version of the target protein pocket.

19. A method of validating a generated molecule, comprising: obtaining at least one generated molecule using text with the method of embodiment 1, wherein the at least one generated molecule bind with a defined protein pocket; and validating that the generated molecule binds with the protein pocket.

Embodiment 20. The method of embodiment 19, wherein the validating is via a simulation on a computing system.

Embodiment 21. The method of embodiment 20, comprising performing docking simulation of the generated molecule with the target protein pocket on a computing system.

Embodiment 22. One or more non-transitory computer readable media storing instructions that in response to being executed by one or more processors, cause a computer system to perform operations, the operations comprising the method of embodiment 1.

Embodiment 23. A computer system comprising: one or more processors; and one or more non-transitory computer readable media storing instructions that in response to being executed by the one or more processors, cause the computer system to perform operations, the operations comprising the method of embodiment 1.

Embodiment 24. One or more non-transitory computer readable media storing instructions that in response to being executed by one or more processors, cause a computer system to perform operations, the operations comprising the method of embodiment 15.

Embodiment 25. A computer system comprising: one or more processors; and one or more non-transitory computer readable media storing instructions that in response to being executed by the one or more processors, cause the computer system to perform operations, the operations comprising the method of embodiment 15.

### Methodologies

The methodologies provided herein can be performed on a computer or in any computing system. In some embodiments, the computer can include generative adversarial networks that are adapted for conditional generation of objects (e.g., generated objects), when a known external variable, such as the condition/property, influences and improves generation and decoding. The model can be validated or trained with a dataset of molecules with a high objective function for the property, where common information is a digit, and then apply the training to a practical problem of generating fingerprints of molecules with desired properties. In addition, the model is capable of metric learning between objects and conditions without negative sampling.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, the present methods can include aspects performed on a computing system. As such, the computing system can include a memory device that has the computer-executable instructions for performing the methods. The computer-executable instructions can be part of a computer program product that includes one or more protocols or algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

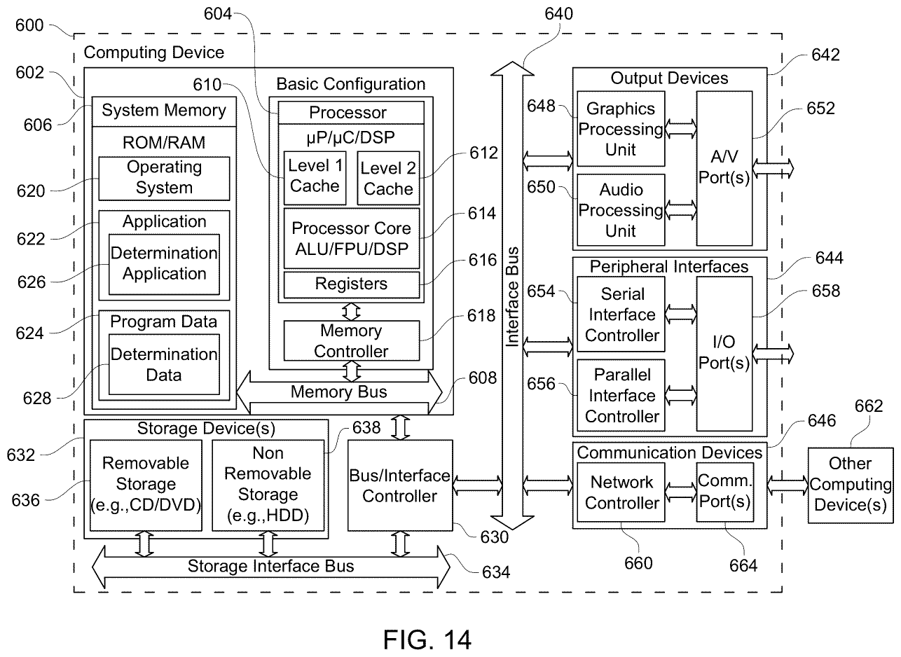

FIG. 14 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data (e.g., determination data 628), such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In some embodiments, a computer program product can include a non-transient, tangible memory device having computer-executable instructions that when executed by a processor, cause performance of a method that can include: providing a dataset having object data for an object and condition data for a condition; processing the object data of the dataset to obtain latent object data and latent object-condition data with an object encoder; processing the condition data of the dataset to obtain latent condition data and latent condition-object data with a condition encoder; processing the latent object data and the latent object-condition data to obtain generated object data with an object decoder; processing the latent condition data and latent condition-object data to obtain generated condition data with a condition decoder; comparing the latent object-condition data to the latent-condition data to determine a difference; processing the latent object data and latent condition data and one of the latent object-condition data or latent condition-object data with a discriminator to obtain a discriminator value; selecting a selected object from the generated object data based on the generated object data, generated condition data, and the difference between the latent object-condition data and latent condition-object data; and providing the selected object in a report with a recommendation for validation of a physical form of the object. The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

In some embodiments, a computer program product can include a non-transient, tangible memory device having computer-executable instructions that when executed by a processor, cause performance of a method described herein.

The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.
Arash Ahmadian, et al. Back to basics: Revisiting reinforce style optimization for learning from human feedback in llms, 2024.
Amr Alhossary, et al. Fast, accurate, and reliable molecular docking with QuickVina 2. Bioinformatics, 31(13):2214-2216, 02 2015. ISSN 1367-4803. doi: 10.1093/bioinformatics/btv082.
Simon Axelrod and Rafael Gomez-Bombarelli. Geom, energy-annotated molecular conformations for property prediction and molecular generation. Scientific Data, 9(1):185, Apr 2022. ISSN 2052-4463. doi: 10.1038/s41597-022-01288-4. URL
Viraj Bagal, Rishal Aggarwal, P. K. Vinod, and U. Deva Priyakumar. Molgpt: Molecular generation using a transformer-decoder model. Journal of Chemical Information and Modeling, 62(9):2064-2076, May 2022. ISSN 1549-9596. Doi: 10.1021/acs.jcim.1c00600.
Ahmet Bakan, Lidio M. Meireles, and Ivet Bahar. ProDy: Protein Dynamics Inferred from Theory and Experiments. Bioinformatics, 27(11):1575-1577, 04 2011. ISSN 1367-4803. doi:10.1093/bioinformatics/btr168.
Esben Jannik Bjerrum. SMILES enumeration as data augmentation for neural network modeling of molecules. CoRR, abs/1703.07076, 2017.
Sid Black, et al. GPT-NeoX-20B: An open-source autoregressive language model. In Proceedings of the ACL Workshop on Challenges & Perspectives in Creating Large Language Models, 2022.
Gayane Chilingaryan, et al. Bartsmiles: Generative masked language models for molecular representations, 2022.
Gabriele Corso, Hannes Stark, Bowen Jing, Regina Barzilay, and Tommi Jaakkola. DiffDock:” Diffusion Steps, Twists, and Turns for Molecular Docking, February 2023.
Tri Dao. FlashAttention-2: Faster attention with better parallelism and work partitioning. 2023.
Tri Dao, Daniel Y. Fu, Stefano Ermon, Atri Rudra, and Christopher Re. FlashAttention: Fast and memory-efficient exact attention with JO-awareness. In Advances in Neural Information Processing Systems, 2022.
Jacob Devlin, et al. BERT: Pre-training of deep bidirectional transformers for language understanding. In Jill Burstein, Christy Doran, and Thamar Solorio (eds.), Proceedings of the 2019 Conference of the North American Chapter of the Association for Computational Linguistics: Human Language Technologies, Volume 1 (Long and Short Papers), pp. 4171-4186, Minneapolis, Minnesota, June 2019. Association for Computational Linguistics. doi: 10.18653/vl/N19-1423.
Jerome Eberhardt, et al. Autodock vina 1.2.0: New docking methods, expanded force field, and python bindings. Journal of Chemical Information and Modeling, 61(8):3891-3898, Aug 2021. ISSN 1549-9596. doi: 10.1021/acs.jcim.1c00203.
Wei Feng, Lvwei Wang, Zaiyun Lin, Yanhao Zhu, Han Wang, Jianqiang Dong, Rong Bai, Huting Wang, Jielong Zhou, Wei Peng, Bo Huang, and Wenbiao Zhou. Generation of 3d molecules in pockets via a language model. Nature Machine Intelligence, Jan 2024. ISSN 2522-5839. doi: 10.1038/s42256-023-00775-6.
Daniel Flam-Shepherd and Alan Aspuru-Guzik. Language models can generate molecules, materials, and protein binding sites directly in three dimensions as xyz, cif, and pdb files, 2023.
Daniel Flam-Shepherd, Kevin Zhu, and Alan Aspuru-Guzik. Language models can learn complex molecular distributions. Nature Communications, 13(1), June 2022. ISSN 2041-1723. doi: 10.1038/s41467-022-30839-x.
Paul G. Francoeur, et al. Three-dimensional convolutional neural networks and a cross-docked data set for structure-based drug design. Journal of Chemical Information and Modeling, 60(9):4200-4215, Sep 2020. ISSN 1549-9596. doi: 10.1021/acs.jcim.0c00411.
Nils-Ole Friedrich, et al. High-quality dataset of protein-bound ligand conformations and its application to benchmarking conformer ensemble generators. Journal of Chemical Information and Modeling, 57(3):529-539, Mar 2017. ISSN 1549-9596. doi: 10.1021/acs.jcim.6b00613.
Rafael Gomez-Bombarelli, et al. Automatic chemical design using a data-driven continuous representation of molecules. ACS Central Science, 4(2):268-276, Feb 2018. ISSN 2374-7943. doi: 10.1021/acscentsci.7b00572.
Jiaqi Guan, Wesley Wei Qian, Xingang Peng, Yufeng Su, Jian Peng, and Jianzhu Ma. 3d equivariant diffusion for target-aware molecule generation and affinity prediction. In International Conference on Learning Representations, 2023.
Thomas A. Halgren. Merck molecular force field. i. basis, form, scope, parameterization, and performance of mmff94. J. Comput. Chem., 17(5-6):490-519, 1996.
Jonathan Ho, Ajay Jain, and Pieter Abbeel. Denoising diffusion probabilistic models. arXiv preprint arxiv:2006.11239, 2020. Sepp Hochreiter and Jurgen Schmidhuber. Long short-term memory.” Neural computation, 9(8):1735-1780, 1997.
Jordan Hoffmann, et al. Training compute-optimal large language models, 2022.
Emiel Hoogeboom, et al. Proceedings of the 39^{th} International Conference on Machine Learning, volume 162 of Proceedings of Machine Learning Research, pp. 8867-8887. PMLR, 17-23 Jul. 2022.
Liegi Hu, et al. Binding moad (mother of all databases). Proteins: Structure, Function, and Bioinformatics, 60(3):333-340, 2005.
Bowen Jing, et al. Torsional diffusion for molecular conformer generation. In Alice H. Oh, Alekh Agarwal, Danielle Belgrave, and Kyunghyun Cho (eds.), Advances in Neural Information Processing Systems, 2022.
John Jumper et al. Highly accurate protein structure prediction with alphafold. Nature, 596(7873):583-589, 2021.
Jared Kaplan, et al. Scaling laws for neural language models, 2020.
A. Katharopoulos, A. Vyas, N. Pappas, and F. Fleuret. Transformers are rnns: Fast autoregressive transformers with linear attention. In Proceedings of the International Conference on Machine Learning (ICML), 2020.
Nitish Shirish Keskar, et al., On large-batch training for deep learning: Generalization gap and sharp minima. In International Conference on Learning Representations, 2017.
Mario Krenn, Florian Hase, AkshatKumar Nigam, Pascal Friederich, and Alan Aspuru-Guzik. Self-referencing embedded strings (SELFIES): A 100% robust molecular string representation. Machine Learning: Science and Technology, 1(4):045024, oct 2020. doi:10.1088/2632-2153/aba947.
Mario Krenn, et al.Selfies and the future of molecular string representations. Patterns, 3(10):100588, October 2022. ISSN 2666-3899. doi: 10.1016/j.patter.2022.100588.
Greg Landrum, et al. strets123. rdkit/rdkit: 2023 09 4 (q3 2023) release, January 2024.
Mike Lewis, et al. Bart: Denoising sequence-to-sequence pre-training for natural language generation, translation, and comprehension, 2019.
Haitao Lin, Yufei Huang, Meng Liu, Xuanjing Li, Shuiwang Ji, and Stan Z. Li. DiffBP: Generative Diffusion of 3D Molecules for Target Protein Binding, December 2022.
Ilya Loshchilov and Frank Hutter. Decoupled weight decay regularization, 2019. Shitong Luo, Jiaqi Guan, Jianzhu Ma, and Jian Peng. A 3d generative model for structure-based drug design, 2022.
Andrew T. McNutt, et al. Gnina 1.0: molecular docking with deep learning. Journal of Cheminformatics, 13(1):43, Jun 2021. ISSN 1758-2946. doi:10.1186/s13321-021-00522-2.
Chenhao Niu, Yang Song, Jiaming Song, Shengjia Zhao, Aditya Grover, and Stefano Ermon. Permutation invariant graph generation via score-based generative modeling, 2020.
Noel M. O'Boyle, et al. Open Babel: An open chemical toolbox. Journal of Cheminformatics, 3(1):33, Oct 2011. ISSN 1758-2946. doi: 10.1186/1758-2946-3-33.
Marcus Olivecrona, Thomas Blaschke, Ola Engkvist, and Hongming Chen. Molecular de novo design through deep reinforcement learning, 2017.
Long Ouyang, et al. Training language models to follow instructions with human feedback, 2022.
Adam Paszke et al. Pytorch: An imperative style, high-performance deep learning library, 2019.
Xingang Peng, Shitong Luo, Jiaqi Guan, Qi Xie, Jian Peng, and Jianzhu Ma. Pocket2 mol: Efficient molecular sampling based on 3d protein pockets. In International Conference on Machine Learning, 2022.
Xingang Peng, Jiaqi Guan, Qiang Liu, and Jianzhu Ma. MolDiff: Addressing the atom-bond inconsistency problem in 3D molecule diffusion generation. In Andreas Krause, Emma Brunskill, Kyunghyun Cho, Barbara Engelhardt, Sivan Sabato, and Jonathan Scarlett (eds.), Proceedings of the 40th International Conference on Machine Learning, volume 202 of Proceedings of Machine Learning Research, pp. 27611-27629. PMLR, 23-29 Jul. 2023a.
Xingang Peng, Jiaqi Guan, Qiang Liu, and Jianzhu Ma. MolDiff: Addressing the atom-bond inconsistency problem in 3D molecule diffusion generation. In Andreas Krause, Emma Brunskill, Kyunghyun Cho, Barbara Engelhardt, Sivan Sabato, and Jonathan Scarlett (eds.), Proceedings of the 40th International Conference on Machine Learning, volume 202 of Proceedings of Machine Learning Research, pp. 27611-27629. PMLR, 23-29 Jul. 2023b.
P G Polishchuk, T I Madzhidov, and A Varnek. Estimation of the size of drug-like chemical space based on GDB-17 data. J Comput Aided Mol Des, 27(8):675-679, August 2013.
Alec Radford, Karthik Narasimhan, Tim Salimans, and Ilya Sutskever. Improving language understanding by generative pre-training. 2018.
Alec Radford, Jeff Wu, Rewon Child, David Luan, Dario Amodei, and Ilya Sutskever. Language models are unsupervised multitask learners. 2019.
Samyam Rajbhandari, Jeff Rasley, Olatunji Ruwase, and Yuxiong He. Zero: Memory optimizations toward training trillion parameter models, 2020.
Jeff Rasley, Samyam Rajbhandari, Olatunji Ruwase, and Yuxiong He. Deepspeed: System optimizations enable training deep learning models with over 100 billion parameters. In Proceedings of the 26th ACM SIGKDD International Conference on Knowledge Discovery & Data Mining, KDD '20, pp. 3505-3506, New York, NY, USA, 2020. Association for Computing Machinery. ISBN 9781450379984. doi: 10.1145/3394486.3406703.
Arne Schneuing, et al. Structure-based drug design with equivariant diffusion models, 2023.
John Schulman, Filip Wolski, Prafulla Dhariwal, Alec Radford, and Oleg Klimov. Proximal policy optimization algorithms, 2017.
Marwin H. S. Segler, Thierry Kogej, Christian Tyrchan, and Mark P. Waller. Generating focused molecule libraries for drug discovery with recurrent neural networks. ACS Central Science, 4(1):120-131, Jan 2018. ISSN 2374-7943. doi: 10.1021/acscentsci.7b00512.
Yang Song, Jascha Sohl-Dickstein, Diederik P. Kingma, Abhishek Kumar, Stefano Ermon, and Ben Poole. Score-based generative modeling through stochastic differential equations, 2021.
Jianlin Su, Yu Lu, Shengfeng Pan, Bo Wen, and Yunfeng Liu. Roformer: Enhanced transformer with rotary position embedding. CoRR, abs/2104.09864, 2021.
Hugo Touvron, et al.Llama 2: Open foundation and fine-tuned chat models, 2023.
Oleg Trott and Arthur J Olson. AutoDock vina: improving the speed and accuracy of docking with a new scoring function, efficient optimization, and multithreading. J Comput Chem, 31(2):455-461, January 2010.
Leandro von Werra, Younes Belkada, Lewis Tunstall, Edward Beeching, Tristan Thrush, Nathan Lambert, and Shengyi Huang. Trl: Transformer reinforcement learning.
David Weininger. Smiles, a chemical language and information system. 1. introduction to methodology and encoding rules. Journal of Chemical Information and Computer Sciences, 28 (1):31-36, Feb 1988. ISSN 0095-2338. doi: 10.1021/ci00057a 005.
R. J. Williams. Simple statistical gradient-following algorithms for connectionist reinforcement learning. Machine Learning, 8:229-256, 1992.
Thomas Wolf, et al.Transformers: State-of-the-art natural language processing. In Proceedings of the 2020 Conference on Empirical Methods in Natural Language Processing: System Demonstrations, pp. 38-45, Online, October 2020. Association for Computational Linguistics.
Wenbo Yu and Alexander D. MacKerell. Computer-Aided Drug Design Methods, pp. 85-106. Springer New York, New York, NY, 2017. ISBN 978-1-4939-6634-9. doi: 10.1007/978-1-4939-6634-9 5.
Gengmo Zhou, et al. Uni-mol: A universal 3d molecular representation learning framework. In The Eleventh International Conference on Learning Representations, 2023.

1. A computer-implemented method comprising:
inputting into a computing system a neural network-based language model for generating a 3D structure of a molecule conditioned by atomic connectivity or a binding of the molecule with a target protein pocket;
inputting large-scale training data into the computing system, which includes a 3D structure of a molecule, a target protein pocket, or a binding of the molecule with the target protein pocket;
training the language model with the large-scale training data set to obtain a pre-trained language model, wherein the pre-trained language model is trained to generate the 3D structures of molecules and/or protein pockets;
inputting finetuning training data into the computing system regarding a second set of a binding of the molecule with the target protein pocket;
training the pre-trained language model with the finetuning training data to obtain a finetuned language model capable of at least one of: generating 3D structures of molecules capable of binding to the target protein pockets or generating 3D structures of molecules bound in the target protein pockets or generating 3D structures of the target protein pockets;
performing reinforcement learning training with the finetuned language model to obtain a trained model of the 3D structure, wherein the reinforcement learning data includes random rotations to protein pocket coordinates of the target protein pocket; and
providing the trained language model capable of generating the 3D structure of at least one generated molecule that fits into the target protein pocket, or a 3D structure of the generated molecule defined by atomic connectivity that fits into the target protein pocket, or a 3D structure of the generated molecule without specific binding.

2. The computer-implemented method of claim 1, further comprising representing the 3D structure as a textual representation.

3. The computer-implemented method of claim 1, further comprising the textual representation including a token scheme to encode 3D spatial data into a sequence of tokens.

4. The computer-implemented method of claim 1, further comprising performing a training-time data augmentation procedure to increase accuracy of 3D structure generation when the training set lacks sufficient 3D coordinate data.

5. The computer-implemented method of claim 1, further comprising representing 3D molecular structures as:
a molecular structure text that starts with a <LIGAND> token followed by a SMILES string, wherein SMILES is a textual encoding of a depth-first pass applied to a molecular graph of a molecule, wherein the SMILES string encodes connectivity between atoms, wherein the SMILES is tokenized so that each atomic symbol has its own token.

6. The computer-implemented method of claim 1, further comprising representing spatial information of the 3D molecular structure by:
generating a molecular structure text with a <XYZ> special token marking an end of a SMILES string, each next line of text is a triplet of X, Y, Z coordinates, an order of the X, Y, Z coordinates corresponds to an order of atoms in the SMILES string;
performing a tokenizing of the X, Y, Z coordinates by assigning:
one token to each integer part with a possible sign;
another token to a 3-digit fractional part including a dot; and
obtaining 6 tokens per each 3D position of the 3D structure.

7. The computer-implemented method of claim 1, further comprising representing 3D structure as protein pocket structures as:
a protein pocket structure text starts with a <POCKET> special token followed by a sequence of atomic symbols, wherein the sequence of atomic symbols is a textual encoding of protein pocket, wherein the sequence of atomic symbols encodes amino acid sequence, wherein each atomic symbol gets its own token.

8. The computer-implemented method of claim 1, further comprising representing spatial information of the 3D structure:
generate protein pocket structure text with a <XYZ> special token marking a beginning of spatial coordinate of the 3D structure, each next line of text is a triplet of X, Y, Z coordinates, an order of the X, Y, Z coordinates corresponds to an order of atoms in the pocket, for each coordinate:
performing a tokenizing of the X, Y, Z coordinates by assigning:
one token to each integer part with a possible sign; and
another token to a 3-digit fractional part including a dot; and
obtaining 6 tokens per each 3D position of the 3D structure.

9. The computer-implemented method of claim 1, wherein training of the trained language model of the 3D structure includes autoregressive objectives to predict each next token in an input of each 3D structure.

10. The computer-implemented method of claim 1, wherein in the training with the large-scale training data set, the language model is trained on pocket blocks and ligand blocks separately from each other, wherein the ligand blocks represent the molecular structure.

11. The computer-implemented method of claim 1, wherein in order to alleviate scarcity of 3D protein structures, the method up samples protein pockets in a 5 to 1 ratio to molecular structures as ligands for the protein pockets.

12. The computer-implemented method of claim 1, during the training of the pre-trained language model with a finetuning data set, further comprising training the pre-trained language model on combined strings which include the target protein pocket followed by a ligand.

13. The computer-implemented method of claim 1, comprising:
randomizing SMILES strings of a molecular structure with a procedure choosing different depth-first passes of a molecular graph of the molecular structure during each training step, wherein a corresponding permutation is applied to the coordinate part.

14. The computer-implemented method of claim 1, comprising:
applying random rotations to a generated protein pocket 3D structure and ligand coordinates of the 3D structure using a same rotation matrix.

15. A computer-implemented method of generating a molecule comprising:
providing a target protein pocket for receiving the molecule;
generating a series of molecules using text with the method of claim 1.

16. The computer-implemented method of claim 15, further comprising defining the target protein pocket to be of a protein of a disease, and determining the generated molecule to bind with the target protein pocket to inhibit the protein of the disease as a therapeutic for the disease.

17. A method of obtaining a molecule, further comprising:
generating at least one generated molecule using text with the method of claim 1, wherein the at least one generated molecule binds with the target protein pocket;
obtaining a physical version of the at least one generated molecule.

18. The method of claim 17, further comprising:
providing a physical version of the target protein pocket;
introducing the physical version of the at least one generated molecule to the physical version of the defined protein pocket; and
detecting binding between the physical version of at least one generated molecule and the physical version of the target protein pocket.

19. A method of validating a generated molecule, comprising:
obtaining at least one generated molecule using text with the method of claim 1, wherein the at least one generated molecule bind with a defined protein pocket; and
validating that the generated molecule binds with the protein pocket.

20. The method of claim 19, wherein the validating is via a simulation on a computing system.

21. The method of claim 20, comprising performing docking simulation of the generated molecule with the target protein pocket on a computing system.

22. One or more non-transitory computer readable media storing instructions that in response to being executed by one or more processors, cause a computer system to perform operations, the operations comprising the method of claim 1.

23. A computer system comprising:
one or more processors; and
one or more non-transitory computer readable media storing instructions that in response to being executed by the one or more processors, cause the computer system to perform operations, the operations comprising the method of claim 1.

24. One or more non-transitory computer readable media storing instructions that in response to being executed by one or more processors, cause a computer system to perform operations, the operations comprising the method of claim 15.

25. A computer system comprising:
one or more processors; and
one or more non-transitory computer readable media storing instructions that in response to being executed by the one or more processors, cause the computer system to perform operations, the operations comprising the method of claim 15.
